(19) United States
(12) Patent Application Publication
(10) Pub. No.: US 2025/0365345 A1
(43) Pub. Date: Nov. 27, 2025

(54) VEHICLE AUTHENTICATION SYSTEM, VEHICLE AUTHENTICATION METHOD, AND STORAGE MEDIUM STORING VEHICLE AUTHENTICATION PROGRAM

(71) Applicant: DENSO CORPORATION, Kariya-City (JP)

(72) Inventors: Koichi TAKAGI, Kariya-City (JP); Toshiaki HORAI, Kariya-cITY (JP); Shiori MANEYAMA, Kariya-city (JP)

(21) Appl. No.: 19/297,592

(22) Filed: Aug. 12, 2025

Related U.S. Application Data
(63) Continuation of application No. PCT/JP2024/005294, filed on Feb. 15, 2024.

(30) Foreign Application Priority Data
Mar. 8, 2023 (JP) 2023-035645
Jan. 18, 2024 (JP) 2024-006121

(51) Int. Cl. H04L 67/12; G06Q 20/14; H04L 9/40

(52) U.S. Cl. CPC H04L 67/12; G06Q 20/14; H04L 63/205

(57) ABSTRACT

A vehicle authentication system is configured to communicate via a network with a server storing information regarding billing system function executable by an occupant of a vehicle; authenticate whether the billing system function can be enabled; and substitute for authentication when connection to the server cannot be established. The alternative authentication is performed when, as a result of a disconnection from the server, the system fails to determine whether the billing system function can be enabled.

### CROSS REFERENCE TO RELATED APPLICATION

The present application is a continuation application of International Patent Application No. PCT/JP2024/005294 filed on Feb. 15, 2024 which designated the U.S. and claims the benefit of priority from Japanese Patent Application No. 2023-035645 filed on Mar. 8, 2023 and Japanese Patent Application No. 2024-006121 filed on Jan. 18, 2024. The entire disclosures of all of the above applications are incorporated herein by reference.

### TECHNICAL FIELD

The present disclosure relates to a vehicle authentication system, a vehicle authentication method, and a vehicle authentication program.

### BACKGROUND

For example, various vehicle devices (e.g., vehicle audio devices) and the like are mounted in a vehicle, and a subscription service applied to the vehicle devices may be provided. Such a subscription service is a service based on a billing system function, and is thus provided under a predetermined contract. At this time, authentication is required to determine whether a contract has been concluded. A related art proposes an authentication function for a function related to a mobile body.

The function described in the related art is an authentication method that presupposes connection to a network. When a mobile body travels, the mobile body may travel through a place where radio waves are difficult to reach, such as a tunnel or a mountainous area. Therefore, even when a device mounted in the mobile body performs communication, a network connection failure may occur, and the mobile body may go offline. When authentication cannot be performed in an offline environment, there is a possibility that an occupant may feel anxiety or that travel may be hindered. Therefore, there is room for considering an alternative authentication method in an offline environment.

### SUMMARY

According to an aspect of the present disclosure, a vehicle authentication system includes at least one of (i) a circuit and (ii) a processor with a memory storing computer program code executable by the processor, the at least one of the circuit and the processor configured to cause the vehicle authentication system to: communicate via a network with a server storing information regarding billing system function executable by an occupant of a vehicle; authenticate whether the billing system function can be enabled; and substitute for authentication when connection to the server cannot be established. Alternative authentication is performed when, as a result of a disconnection from the server, the system fails to determine whether the billing system function can be enabled.

### BRIEF DESCRIPTION OF DRAWINGS

Objects, features and advantages of the present disclosure will become more apparent from the following detailed description made with reference to the accompanying drawings. In the drawings:

FIG. 1A is a block configuration diagram of a vehicle authentication system according to a first embodiment;

FIG. 1B is a first flowchart schematically illustrating processing content;

FIG. 2 is a second flowchart schematically illustrating processing content;

FIG. 3 is a third flowchart schematically illustrating processing content;

FIG. 4 is a fourth flowchart schematically illustrating processing content;

FIG. 5 is a fifth flowchart schematically illustrating processing content;

FIG. 6A is a sixth flowchart schematically illustrating processing content;

FIG. 6B is a seventh flowchart schematically illustrating processing content;

FIG. 7A is an eighth flowchart schematically illustrating processing content;

FIG. 7B is a ninth flowchart schematically illustrating processing content;

FIG. 8 is a block configuration diagram of a vehicle authentication system according to a second embodiment;

FIG. 9 is a first flowchart schematically illustrating processing content;

FIG. 10A is a second flowchart schematically illustrating processing content;

FIG. 10B is a third flowchart schematically illustrating processing content;

FIG. 10C is a fourth flowchart schematically illustrating processing content;

FIG. 11A is a first flowchart schematically illustrating processing content according to a third embodiment;

FIG. 11B is a second flowchart schematically illustrating processing content;

FIG. 11C is a first explanatory diagram of a display screen example;

FIG. 11D is a third flowchart schematically illustrating processing content;

FIG. 11E is a second explanatory diagram of the display screen example;

FIG. 11F is a third explanatory view of the display screen example;

FIG. 12 is a fourth flowchart schematically illustrating processing content;

FIG. 13A is a fifth flowchart schematically illustrating processing content; and

FIG. 13B is a sixth flowchart schematically illustrating processing content.

### DETAILED DESCRIPTION

The present disclosure provides a vehicle authentication system, a vehicle authentication method, and a vehicle authentication program that enable alternative authentication in an offline environment.

According to one aspect of the present disclosure, a vehicle authentication system includes: a network communication section configured to communicate via a network with a server storing information regarding billing system function executable by an occupant of a vehicle; an authentication section configured to authenticate, via the network communication section, whether the billing system function can be enabled; and an alternative authentication section configured to substitute for authentication by the authentication section when connection to the server cannot be established via the network communication section. The alternative authentication section performs alternative authentication when, as a result of a disconnection from the server, the authentication section fails to determine, via the network communication section, whether the billing system function can be enabled.

The alternative authentication section substitutes for authentication by the authentication section when the connection to the server is unestablishable through the network communication section. The alternative authentication section substitutes for authentication by the authentication section when the authentication section fails to determine, via the network communication section, whether the billing system function is implementable as a result of an interruption in the connection with the server, and thus, the alternative authentication section can perform alternative authentication even in the offline environment.

Hereinafter, some embodiments of a vehicle authentication system and a vehicle control system will be described with reference to the drawings. In each of the embodiments described below, configurations that perform equal or similar operations are denoted by equal or similar reference numerals, and description thereof is omitted as necessary.

### First Embodiment

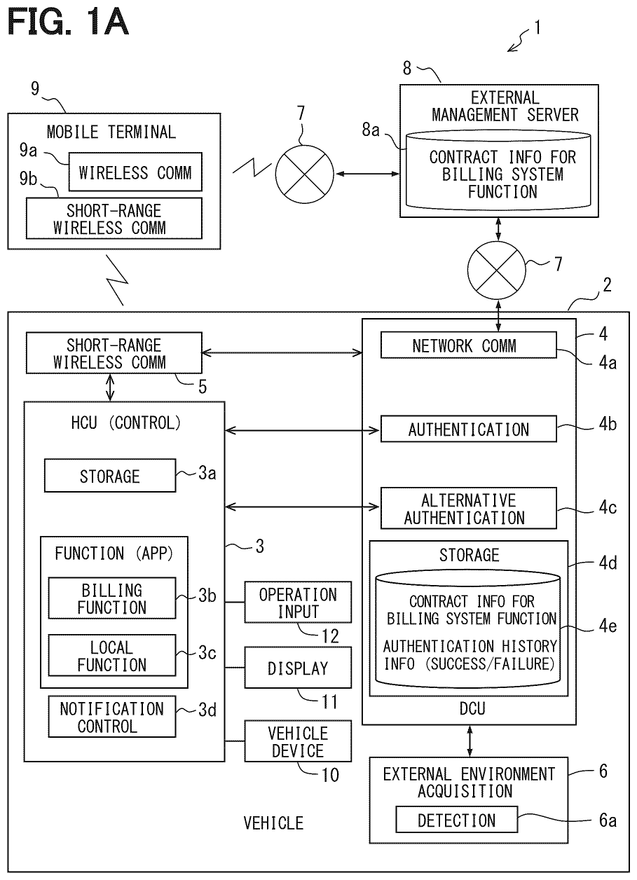

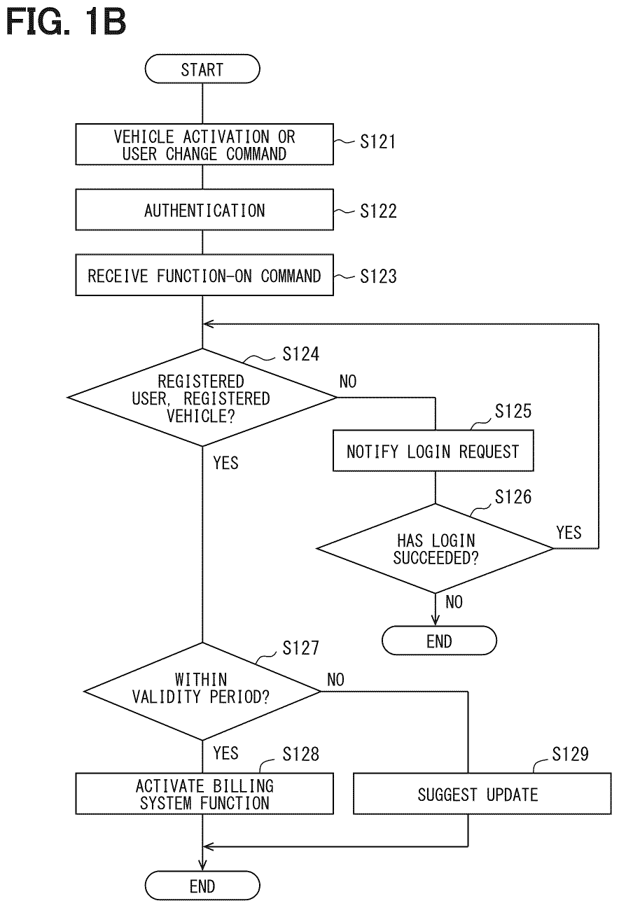

A first embodiment will be described with reference to FIGS. 1A to 7B. A vehicle system 1 shown in FIG. 1A includes a human machine interface control unit (HCU) 3, a domain control unit (DCU) 4, and other electronic control units (ECUs) (not shown), which are installed inside a vehicle 2 and connected via a network, and includes an external management server 8 outside the vehicle 2 as a server. A user may have a mobile terminal 9, such as a smartphone, a tablet, or a notebook computer, in or around the vehicle 2, and the mobile terminal 9 also constitutes the vehicle system 1. The vehicle system 1 is used as a vehicle authentication system and a vehicle control system.

The HCU 3, the DCU 4, the external management server 8, and the mobile terminal 9 can be communicably connected via a network 7, thereby constituting the vehicle system 1. HCU stands for human machine interface control unit. DCU stands for domain control unit. The network 7 is a wired communication network, a wireless communication network, or the like.

### (HCU 3)

The HCU 3 constitutes a display system ECU. ECU stands for electronic control unit and is an electronic control apparatus. The HCU 3 includes a processor, a storage section 3a, an input/output interface (I/O), and a bus connecting these components, and functions as a control section that executes various controls by executing a program stored in the storage section 3a. The storage section 3a represents a non-transitory tangible storage medium that non-transiently stores computer-readable programs and data. The non-transitory tangible storage medium is achieved by a semiconductor memory or the like. A short-range wireless communication section 5 is connected to the HCU 3, and the short-range wireless communication section 5 enables the HCU 3 to communicate with a short-range wireless communication section 9b of the mobile terminal 9.

The HCU 3 executes various functions, for example, functions as a billing function 3b, a local function 3c, and a notification control section 3d by executing application programs (hereinafter, applications) stored in the storage section 3a. A display apparatus 11 is connected to the HCU 3. The display apparatus 11 is formed of a liquid crystal display, an organic EL display, or the like, and is configured to display content in monochrome or full graphics. The display apparatus 11 is based on a center information display or the like. An operation input section 12 is connected to the HCU 3. The operation input section 12 is formed of a touch panel configured on the surface of the display apparatus 11 or a mechanical switch configured beside the display apparatus 11, receives a user operation input, and outputs an operation signal to the HCU 3. Based on operation signals of the operation input section 12, the HCU 3 can execute various functions. A vehicle device 10 is connected to the HCU 3 or the DCU 4.

Functions of applications that can be achieved by the HCU 3 can be classified into the billing function 3b and the local function 3c. Here, the billing function 3b represents a function that is executed based on the Contract information for the billing system function contracted with the user of the vehicle 2. When obtaining the verification of the Contract information for the billing system function of the vehicle device 10, the HCU 3 becomes an execution section that executes the contracted billing function 3b. The local function 3c represents a function executed by an application installed in advance in the storage section 3a without billing, and represents a function that can be executed without a contract of the billing system function.

### (DCU 4)

The DCU 4 constructs a centralized cockpit electronic system on an integrated software and hardware platform and is configured by mounting a storage section 4d in which a database 4e is constructed. The DCU 4 stands for a domain control unit.

The DCU 4 is configured by being connected to an external environment acquisition section 6. The external environment acquisition section 6 acquires the external environment information of the vehicle 2. The external environment acquisition section 6 is connected to a detection section 6a. The detection section 6a is configured using a sensor for acquiring external environment information of the vehicle 2. Examples thereof include a temperature sensor that detects the outside temperature of the vehicle 2, an illuminance sensor that detects the sunshine illuminance outside the vehicle 2, a front view camera, a side view camera, a corner view camera, a back view camera, an electronic mirror, a laser radar using light detection and ranging (LiDAR), and a surrounding monitoring sensor that monitors the surroundings of the vehicle 2 using a millimeter wave radar.

The detection section 6a can also detect the status of the user by using an occupant monitor. The occupant monitor detects a status of an occupant riding in the vehicle 2 or operation statuses of various operation devices. The occupant monitor includes a camera that detects a status of an occupant in a driver seat, an occupant seat, or a rear seat by imaging the status of the occupant with an image sensor and outputs an imaging signal. The occupant status monitor of a driver is referred to as DSM. DSM stands for driver status monitor. The DCU 4 includes a function as an individual recognition section that identifies, based on a detection result of the occupant monitor, the user riding in the vehicle 2.

The DCU 4 is communicably connected to apparatuses such as the HCU 3 and other ECUs (not shown), and can transmit and receive various types of information to and from each other. The electronic control apparatus including the DCU 4, the HCU 3, and other apparatuses includes functions, such as a travel control system unit that performs travel control of the vehicle 2, a surrounding monitoring system unit that monitors the surroundings of the vehicle 2, and a display system unit that presents information to the user through the display apparatus 11.

The travel control system unit performs driving control by manual driving or automated driving using a gasoline engine, a diesel engine, an electric motor, or the like. The travel control system unit achieves a manual driving control mode by manual driving or an automated driving mode according to automated driving levels of various stages. In the automated driving mode, a travel control system ECU for automated driving drives a driving actuator to execute driving assistance and automated driving at a corresponding predetermined level.

For example, in driving assistance at level I, it is possible to execute automatic braking for avoiding collision with an obstacle, follow-up travel for travel following a preceding vehicle, or travel lane deviation prevention travel for controlling so as not to deviate from lanes on both sides. In automated driving at level II, an automated driving mode can be executed in combination with driving assistance at level I, or with automated driving under specific conditions, such as automatically overtaking a slow vehicle 2, on an expressway, when existing, or automatically performing merging and divergence on an expressway. In automated driving at level II, the driver is obliged to perform monitoring. In automated driving at level III or higher, a travel control system executes all driving tasks while a surrounding monitoring system in the vehicle 2 performs monitoring, but detailed description is omitted. Thus, travel control in each of the driving modes of manual driving and automated driving can be achieved.

The DCU 4 is configured to be connectable to the network 7 outside the vehicle through a network communication section 4a. The network communication section 4a represents a block for mediating communication between the internal and external apparatuses of the vehicle 2. The network communication section 4a performs communication via the network 7 with the external management server 8 that stores information on a billing system function that is implementable by the user who is the occupant of the vehicle 2.

The DCU 4 executes applications stored in the storage section 4d to execute various functions, for example, functions of an authentication section 4b and an alternative authentication section 4c, which will be described later. The storage section 4d represents a non-transitory tangible storage medium that non-transiently stores computer-readable programs and data. The non-transitory tangible storage medium is achieved by a semiconductor memory or the like.

A database 4e is constructed in the storage section 4d. The database 4e is used as an authentication history information storage section that stores authentication history information indicating a result (success/failure) of authentication by the authentication section 4b, along with the date and time. The database 4e stores and holds the Contract information for the billing system function.

The authentication section 4b represents a function of authenticating, through the network communication section 4a, whether the billing system function is implementable. The alternative authentication section 4c represents a function of substituting authentication by the authentication section 4b when the connection to the external management server 8 is unestablishable through the network communication section 4a.

### (Contract Between Mobile Terminal 9 and Billing System Function)

The user riding in the vehicle 2 has the mobile terminal 9. The mobile terminal 9 is a terminal that can be brought into the vehicle interior, and includes an interface for operation input, a display, and the like. The mobile terminal 9 is a terminal capable of performing various operation inputs and notification processes.

The mobile terminal 9 includes a processor, a memory, and I/O (none of which are shown). The mobile terminal 9 is equipped with a wireless communication section 9a for wirelessly communicating with the external management server 8 and the like via the network 7. The mobile terminal 9 is equipped with a short-range wireless communication section 9b that performs short-range communication with the short-range wireless communication section 5 by a wireless local-area network (LAN) such as WiFi (registered trademark), or a short-range communication technology such as Bluetooth (registered trademark).

An application for the vehicle 2 is installed in the memory of the mobile terminal 9, and when the mobile terminal 9 executes the application for the vehicle, a control command related to the vehicle 2 can be issued from the user, or information on the vehicle 2 can be acquired from the HCU 3 or the DCU 4 on the vehicle 2 side. At this time, the user can set setting information related to the vehicle device 10 by operating the mobile terminal 9. The vehicle device 10 referred to herein includes, but is not limited to, an air conditioner (air conditioning device), a vehicular audio-visual device, and the like.

The user operates the operation input section 12 or the mobile terminal 9 to enter into a purchase or lease contract for a subscription service related to the vehicle device 10. Hereinafter, the subscription service may be abbreviated as “subscription”. Through the network 7, the user inputs predetermined identification information as a new ID from the operation input section 12 or the mobile terminal 9 to a form provided by the management provider of the predetermined external management server 8. The user accepts contractual terms, thereby entering into a purchase contract or a lease contract for the subscription service with the subscription provider using the authorized new ID. Such a subscription service may have a validity period or may be indefinite.

The Contract information for the billing system function related to the subscription service is then registered in a database 8a of the external management server 8 in association with the user. The external management server 8 stores the Contract information for the billing system function in the database 8a. The Contract information for the billing system function is also registered in the database 4e of the DCU 4.

The Contract information for the billing system function is information indicating the purchase status of the subscription service for each user of the vehicle 2 such as an individual, a corporation, or an association. The Contract information for the billing system function includes the following: purchase information or lease information for various functions by the user; identification information of the user; billing information per predetermined period or one-time billing information; and validity period information indicating a validity period for providing the subscription service. The Contract information for the billing system function for each of a large number of users is stored in the database 8a in association with, for example, the name or identification number of each user.

As the subscription service for the billing system function, a music streaming subscription service for the vehicle audio device and a video streaming subscription service that enables display on the display apparatus 11 are provided. Examples of the subscription service may further include a subscription service for a comfort function, such as a seat heater, for staying comfortably in the vehicle interior, and a subscription service for a drive mode that enables a change in manual driving or automated driving performance of the vehicle 2. Examples of the subscription service may also include a subscription service for driving assistance of the automated driving mode or a function at each level of automated driving, and a subscription service for lighting up the vehicle interior of the vehicle 2.

Hereinafter, the processes inside the vehicle 2 after the power supply is turned on will be described.

(Case where Connection with External Management Server 8 is Good)

When the driver turns on a power switch using an ignition switch, a power button, or the like, the HCU 3, the DCU 4, and the like is powered on. The network communication section 4a of the DCU 4 establishes connection with the external management server 8 via the network 7 and establishes a session with the external management server 8. As long as the connection with the external management server 8 is not interrupted, the network communication section 4a of the DCU 4 determines that the communication situation through the network 7 is good. At this time, the network communication section 4a becomes capable of communication with the external management server 8.

The DCU 4 performs authentication using the authentication section 4b by verifying the Contract information for the billing system function stored in the database 4e against the Contract information for the billing system function of the database 8a stored in the external management server 8.

As a result of the communication processing performed by the DCU 4 from the network communication section 4a to the external management server 8 via the network 7, when the authentication section 4b can authenticate that the billing system function is implementable, authentication history information indicating that authentication has succeeded is stored in the database 4e. When the DCU 4 determines that the billing system function is implementable, the date of confirmation or the like of the Contract information for the billing system function indicated as implementable is updated in the database 4e as necessary.

Thus, the Contract information for the billing system function stored in the database 8a by the external management server 8 and the Contract information for the billing system function stored in the database 4e of the DCU 4 inside the vehicle 2 are updated as needed. The Contract information for the billing system function is updated periodically, for example, every several days, every month, or the like.

An authentication operation of the authentication section 4b as to whether the billing system function is implementable will be described with reference to FIG. 1B. When the vehicle 2 is started in S121, the DCU 4 performs online authentication using the authentication section 4b in S122. Similarly, when the occupant of the vehicle 2 issues a change command, the authentication section 4b performs online authentication upon receiving a function-on command in S122.

When online authentication is performed on the external management server 8, login information is required to be input. When the login information of the occupant (user) has already been registered in the database 4e of the DCU 4, or when the identification information of the vehicle 2 has already been registered in the database 4e of the DCU 4 as the login information, the process proceeds to S127.

When it is determined in S124 that the occupant (user) is not a registered occupant and the identification number is not the registered vehicle 2, the DCU 4 notifies the occupant of the vehicle 2 of a login request to log in S125. As a result of the notification of the login request, the occupant attempts to log in. Examples of an authentication method for the ID of the occupant include authentication of identification information (such as a vehicle body number) of the vehicle 2, personal authentication using the occupant monitor of the detection section 6a described above, and authentication by input of an individual password. When the occupant successfully logs in, the process returns to S124, and YES is determined in S124.

The DCU 4 refers to the Contract information for the billing system function of the occupant who has logged in from the database 4e, and determines whether the billing system function is within the validity period in S127. When the billing system function is within the validity period, the DCU 4 activates the billing system function in S128. Conversely, when the billing system function is not within the validity period, the update of the subscription to the billing system function is suggested in S129. The update may be urged along with notification of information such as “The validity period of the subscription contract has expired on MM/DD. Do you want to update?”. Here, when the acceptance of the update is obtained, the DCU 4 communicates with the external management server 8, updates the contract information stored in each of the database 4e or the database 8a, and extends the validity period.

When non-registration in the database 4e of the DCU 4 is determined in S124, communication may be performed with the external management server 8 to verify the Contract information for the billing system function registered in the database 8a of the external management server 8 and update the information.

(Case where Connection with External Management Server 8 is Unestablishable, Such as During Travel of Vehicle 2)

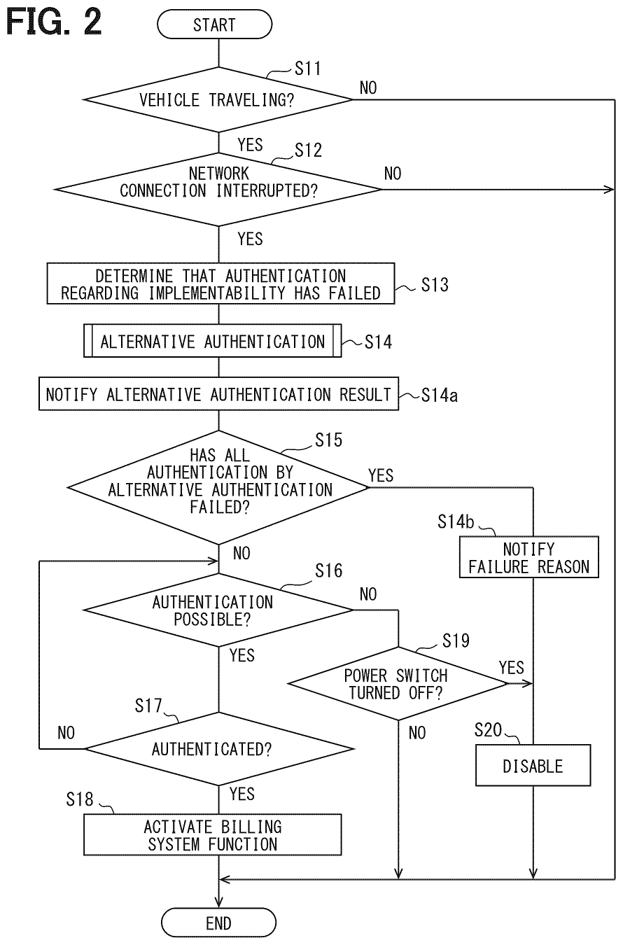

Hereinafter, the processing operation during travel of the vehicle 2 will be described with reference to FIGS. 2 to 6B. In S11 of FIG. 2, during travel of the vehicle 2 along a road, the network communication section 4a periodically determines, through the network 7, whether the connection with the external management server 8 can be maintained in S12.

As a result of the network communication section 4a performing communication processing with the external management server 8 through the network 7, when the network connection is interrupted due to a weak radio wave reception environment or the like, the authentication section 4b cannot authenticate whether the billing system function is implementable and determines that authentication has failed in S13. In this case, the DCU 4 stores the authentication history information indicating that authentication has failed in the database 4e.

As a result of an interruption in the connection through the network 7 in S14, when the determination by the authentication section 4b via the network communication section 4a as to whether the billing system function is implementable fails, the DCU 4 performs alternative authentication (the function of the alternative authentication section 4c). At this time, the DCU 4 performs alternative authentication based on the information stored in the storage section 4d or the storage section 3a prepared on the vehicle 2 side (the function of the alternative authentication section 4c). In S14a, when the DCU 4 determines whether the billing system function is implementable through alternative authentication, the notification control section 3d may control notification to the occupant of the determination result by the alternative authentication section 4c as to whether the billing system function is implementable. The occupant is then able to understand the implementation result of the alternative authentication.

When the DCU 4 suddenly stops the billing system function when authentication by the authentication section 4b fails, the driver may be surprised and the driving may be hindered. In order to solve this problem, when the billing system function relates to the safety and security of the occupant, the continuation of the use of the billing system function may be unconditionally permitted (the function of the alternative authentication section 4c). When the DCU 4 is using the billing system function at the timing for determining the stop of the billing system function when authentication by the authentication section 4b fails, the continuation of the use of the billing system function may be unconditionally permitted without determining the stop (the function of the alternative authentication section 4c).

In addition, when the billing system function, for which implementability is to be determined, is applicable to at least one of a function necessary for the travel of the vehicle 2, a function necessary for the safety of the user (occupant), and a function for making the internal environment of the vehicle 2 comfortable, the DCU 4 may determine that the billing system function is implementable and perform alternative authentication (the function of the alternative authentication section 4c) As described individually below, it may be determined that the billing system function is implementable when any two or more of these functions are applicable.

### (Functions Necessary for Travel of Vehicle 2)

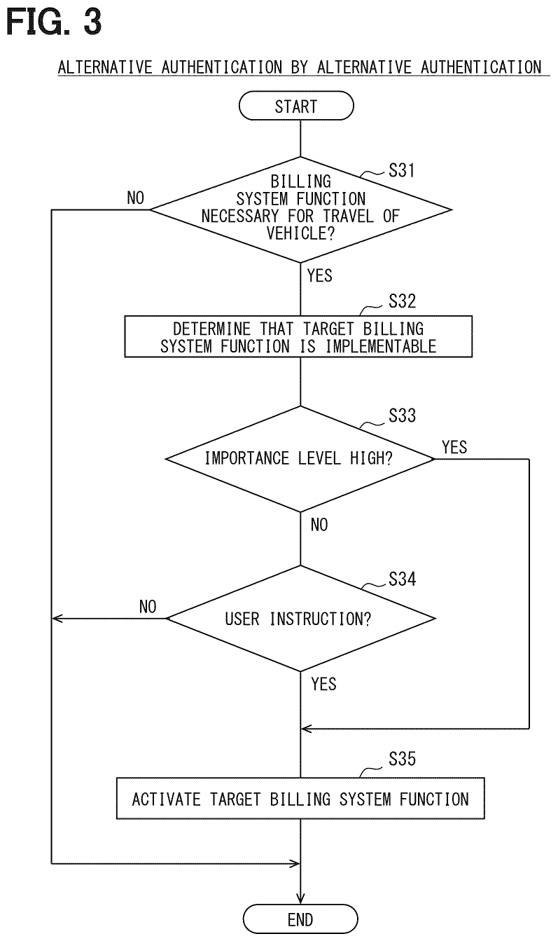

Specifically, as shown in FIG. 3, in S31, as a result of determining whether the billing system function, for which implementability is to be determined, is a function necessary for the travel of the vehicle 2, when the DCU 4 determines that the function is necessary, the processing in and after S32 is performed by the function of the alternative authentication section 4c.

For example, when driving the vehicle 2, the user sets the drive mode using the operation input section 12 in order to change the travel performance of the vehicle 2. When the drive mode is set, the travel control system ECU sets travel performance corresponding to the drive mode and controls the travel of the vehicle 2. In this drive mode, the travel control is enabled by assisting the operation when the user performs manual driving. In a standard normal mode, a mode focusing on balanced performance between operability and comfort is preset.

In a sport mode, a mode is set in which the response characteristics of acceleration and deceleration are enhanced compared to the normal mode. A race drive mode is a mode in which the response performance of acceleration and deceleration is further actively enhanced compared to the sport mode. A comfort mode is a mode focusing on comfort.

A snow mode is a mode in which the drive performance of the vehicle 2 is suitable for travel on a snowy road. An eco-mode is a mode in which fuel saving performance is enhanced compared to the normal mode. When the user selects and purchases or leases these drive modes as the billing system functions, the user can select the drive modes by operating the operation input section 12.

These drive modes include functions necessary for the travel of the vehicle 2. For example, in the sport mode or the race drive mode, the HCU 3 visually presents samples of a gear shift change, an accelerator work, and a brake work on the display apparatus 11, and provides a service for causing the user to operate the gear, the accelerator, and the brake in accordance with the samples. In the snow mode, a service that can make the drive performance of the vehicle 2 suitable for travel on a snowy road is provided.

Even when these drive modes cannot be authenticated as billing system functions through the network communication section 4a, when it is determined, in S31, that the billing system function is a function necessary for the travel of the vehicle 2, the DCU 4 determines, in S32, that the target billing system function is implementable.

In S33, the DCU 4 determines the importance level of the target billing system function. This importance level indicates the degree of necessity for the travel of the vehicle 2, and is preset stepwise from a necessary function with increasing importance levels. The importance level information is stored in advance in the storage section 4d. For example, the snow mode is one of the functions having a high importance level for the vehicle 2 to safely travel on a snowy road. Since the race drive mode is a mode with relatively strong personal preference or taste, the race drive mode is one of the functions having a low importance level for the travel of the vehicle 2. Here, an example of the importance level setting has been described, but the setting is not limited to this order setting of importance levels.

When the importance level is determined to be lower than a predetermined level in S33, the DCU 4 can activate the target billing system function in S35 and make the subscription service for the billing system function available after obtaining acceptance through a user operation instruction in S34. Conversely, when the DCU 4 determines that the importance level of the target billing system function is higher than the predetermined level, the DCU 4 can forcibly activate the target billing system function and make the subscription service available in S35 without asking the user for an instruction. This enables the user to use the corresponding billing system function.

### (Functions Necessary for Safety of User (Occupant))

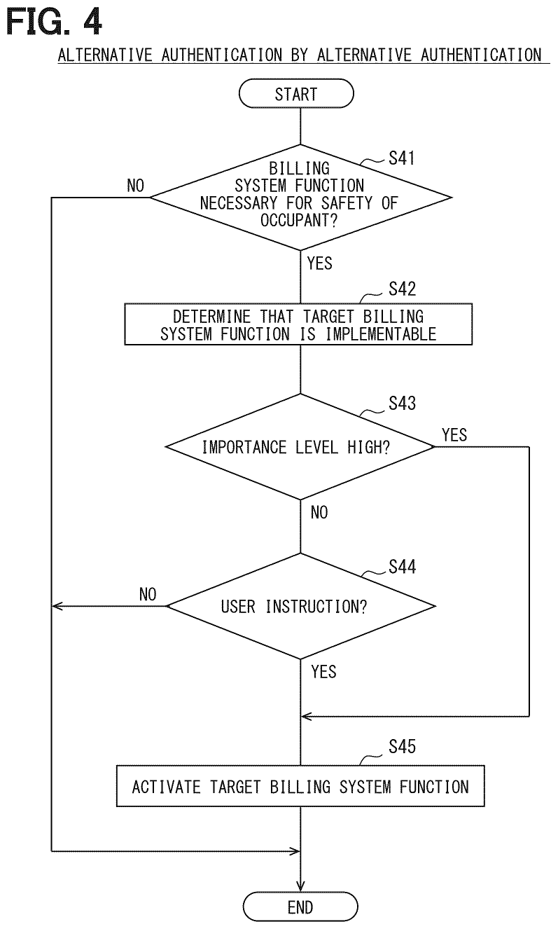

Further, as shown in FIG. 4, in S41, as a result of determining whether the billing system function, for which implementability is to be determined, is a function necessary for the safety of the user, when the DCU 4 determines that the function is necessary, the processing after S42 is executed by the alternative authentication section 4c.

For example, the vehicle 2 is provided with driving modes of manual driving and automated driving. When driving the vehicle 2, the user changes the driving mode setting of the vehicle 2 by performing an operation input from the operation input section 12. When this driving mode is set, the travel control system ECU controls the travel of the vehicle 2 in accordance with this driving mode.

In the automated driving mode, a method of driving assistance or automated driving differs for each level. When the user purchases or leases the automated driving mode at each level as a billing system function, the user can select this driving mode by operating the operation input section 12. For example, it is possible to selectively implement each function such as a radar cruise control function (LCC), an emergency stop function for collision prevention, and an accelerator depression prevention function.

Even when these driving modes cannot be authenticated as billing system functions through the network communication section 4a, when it is determined, in S41 of FIG. 4, the billing system function is a function necessary for the safety of the occupant, the DCU 4 determines, in S42, that the target billing system function is implementable.

Next, in S43, the DCU 4 determines the importance level of the target billing system function. This importance level indicates the degree of necessary for the safety of the occupant, and is preset stepwise from a necessary function with increasing importance levels. The importance level information is stored in advance in the storage section 4d.

For example, the emergency stop function for collision prevention is a necessary and important function for preventing a collision accident with another vehicle 2 or an obstacle in consideration of safety. Therefore, the importance level is set to be relatively high. The accelerator depression prevention function is an important function for preventing a collision accident with an obstacle in consideration of safety, and thus the importance level is set to be relatively high. The radar cruise control function is a function of follow-up travel following a vehicle 2 traveling in front of the subject vehicle 2 while maintaining a constant interval, and is set to have a relatively low importance level compared to the emergency stop function and the accelerator depression prevention function. Here, an example of the importance level information setting has been described, but the setting is not limited to this order setting of importance levels.

When the importance level is determined to be lower than a predetermined level in S43, the DCU 4 obtains acceptance through a user operation instruction in S44, and then activates the target billing system function in S45. Conversely, when determining that the importance level of the target billing system function is higher than a predetermined level, the DCU 4 forcibly activates the target billing system function in S45 without seeking an instruction from the user. This enables the user to use the corresponding billing system function.

The external management server 8 or the storage section 4d may be caused to store whether the target billing system function is a billing system function related to safety and security, and whether the importance level is higher than a predetermined level. When the target billing system function is a billing system function related to security and safety, the DCU 4 may activate the billing system function unconditionally, using the alternative authentication section 4c. Thus, when the license authentication for the billing system function fails, and the billing system function to be authenticated is a function related to the safety and security of the occupant, the DCU 4 can unconditionally execute the billing system function.

### (Function for Making Internal Environment of Vehicle 2 Comfortable)

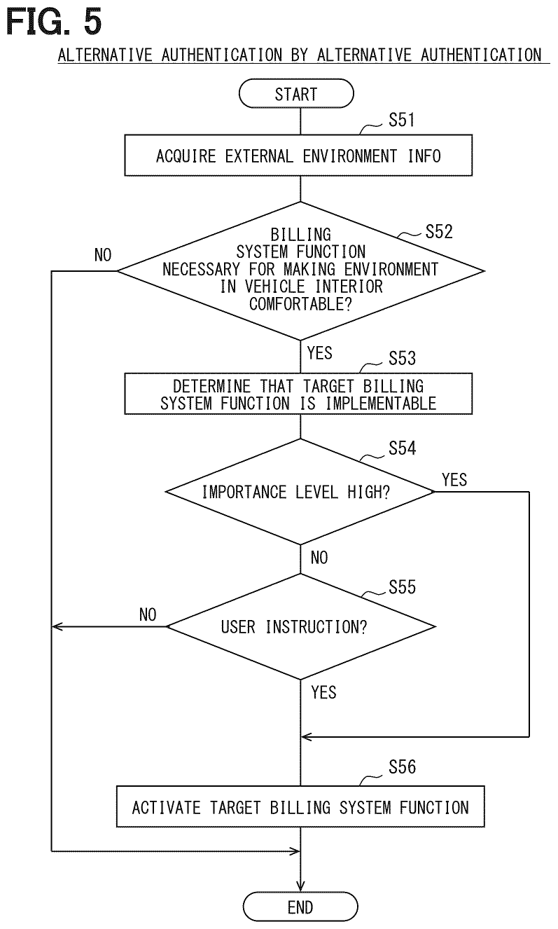

As shown in FIG. 5, in S52, the DCU 4 determines, by the alternative authentication section 4c, whether the billing system function, for which implementability is to be determined, is a comfort function for making the environment in the vehicle interior comfortable. The DCU 4 determines, in S53, that the target billing system function is implementable when determining that the function corresponds to the comfort function.

When, the DCU 4 determines, in S52, whether to implement the comfort function for making the internal environment of the vehicle 2 comfortable, the DCU 4 desirably acquires external environment information in S51 prior to this process, and performs alternative authentication by adding the external environment information of the vehicle 2 to determination conditions for whether the billing system function is implementable. For example, outside temperature information acquired by the temperature sensor or illuminance information acquired by the illuminance sensor may be used as the external environment information.

When determining that the outside temperature is lower than a predetermined standard temperature, the DCU 4 determines that the heating function in the vehicle interior is implementable, using the vehicle device 10 for heating, such as the air conditioner or the seat heater (the function of the alternative authentication section 4c). When determining that the outside temperature is higher than the predetermined standard temperature, the DCU 4 determines that the cooling is implementable, using the vehicle device 10 for cooling, such as the air conditioner (the function of the alternative authentication section 4c).

The subscription service for lighting up the vehicle interior of the vehicle 2 also corresponds to the comfort function. In this case, the DCU 4 uses illuminance information acquired by the illuminance sensor as the external environment information of the vehicle 2 to determine whether the billing system function is implementable (the function of the alternative authentication section 4c). For example, when determining that the illuminance outside the vehicle is lower than a predetermined value, the DCU 4 determines that lighting up with an LED or the like installed in the vehicle interior is implementable (the function of the alternative authentication section 4c). Conversely, when determining that the illuminance outside the vehicle is equal to or greater than the predetermined value, the DCU 4 disables the lighting up (the function of the alternative authentication section 4c).

In addition, a music streaming service, video and movie streaming subscription services, and the like also correspond to comfort functions. Even when these billing system functions as the comfort functions cannot be authenticated through the network communication section 4a, when it is determined, in S52 of FIG. 5, that the billing system function as the comfort function corresponds to a function necessary for comfort, the DCU 4 determines, in S53, that the target billing system function is implementable (the function of the alternative authentication section 4c).

Next, in S54, the DCU 4 determines the importance level of the target billing system function. This importance level indicates the degree of necessity for making the internal environment of the vehicle 2 comfortable, and is preset stepwise from a necessary function considered most important with increasing importance levels. The importance level information is stored in advance in the storage section 4d.

For example, the cooling and heating functions in the vehicle interior are set to have a relatively high importance level among the comfort functions. The function of lighting up the interior of the vehicle 2 is set to have a relatively low in importance level.

Here, an example of the importance level setting has been described, but the setting is not limited to this order setting of importance levels.

When the importance level is determined to be lower than a predetermined level in S54, the DCU 4 obtains acceptance through a user operation instruction in S55, and then activates the target billing system function in S56. Conversely, when the DCU 4 determines that the importance level of the target billing system function is higher than the predetermined level, the DCU 4 forcibly activates the target billing system function in S56 without seeking a user instruction. This enables the user to use the corresponding billing system function.

The description will be continued by returning the reference drawing to FIG. 2. The DCU 4 acquires a result of performing alternative authentication by the alternative authentication section 4c in S14, and notifies the alternative authentication result in S14a. For example, through the HCU 3, the DCU 4 may cause the display apparatus 11 to display “Alternative authentication succeeded (or failed).” (first notification information). The DCU 4 may communicate with the mobile terminal 9 to display on the display screen of the mobile terminal 9. Subsequently, the DCU 4 may cause the display apparatus 11 or the mobile terminal 9 to display “The function will be continued. The available period is until the vehicle stops and the engine is turned off.” (second notification information).

The first notification information and the second notification information may be continuously transmitted and notified in time series, or may be simultaneously notified. The DCU 4 may cause the display apparatus 11 or the mobile terminal 9 to display a predetermined special icon representing the alternative function only during a period in which the function is permitted by the alternative authentication section 4c.

In S15, the DCU 4 determines whether all authentication by the alternative authentication section 4c has failed. When all authentication by the alternative authentication section 4c has failed, the DCU 4 disables the subscription service for the target billing system function in S20. When authentication by the authentication section 4b and authentication by the alternative authentication section 4c have both failed, the DCU 4 may particularly notify the reason for the authentication failure through the HCU 3 in S14b. For example, the reason such as “Authentication failed due to an interruption in the network connection.” may be notified. The vehicle occupant is then able to understand the reason for unavailability, and support can be provided so as not to cause a sense of mistrust in the vehicle occupant. Although an interruption in the network connection has been exemplified here, even when the authentication fails due to a cause other than an interruption in the communication through the network 7, the reason may be notified.

When authentication by the alternative authentication section 4c has not all failed in S15, the DCU 4 makes the billing system function continuously available through authentication by the alternative authentication section 4c, as described above with reference to FIGS. 3 to 5. Even after authentication by the alternative authentication section 4c is completed, the DCU 4 determines, in S16, whether the authentication section 4b can perform authentication through the network 7. That is, the DCU 4 determines whether online authentication has become possible.

When authentication by the authentication section 4b becomes possible in S16, the authentication section 4b performs authentication or confirmation in S17, whereby the DCU 4 activates the billing system function in S18. That is, the determination result by the alternative authentication section 4c as to whether the billing system function is implementable is kept valid until the authentication section 4b becomes able to perform authentication. This is because alternative authentication by the alternative authentication section 4c becomes unnecessary when the authentication section 4b performs authentication. When the authentication section 4b cannot perform authentication in S17, the DCU 4 proceeds to S16 and continues to stand by until authentication becomes possible. That is, the DCU 4 continues to stand by until online authentication becomes possible.

For example, when detecting that the power switch of the vehicle 2 has been turned off without authentication by the authentication section 4b, the DCU 4 determines NO in S16 and YES in S19 Thus, when the alternative authentication section 4c has performed alternative authentication for the target billing system function, the DCU 4 also disables the alternative authentication by the alternative authentication section 4c on condition that the power switch has been turned off.

That is, the DCU 4 keeps valid the determination result by the alternative authentication section 4c as to whether the billing system function is implementable, until the vehicle 2 stops and the power supply of the vehicle 2 is cut off, while authentication by the authentication section 4b is not possible. For example, although the billing system function is enabled before driving is started, it is conceivable that the validity period expires during driving.

In this case, the DCU 4 may determine that the billing system function is implementable unconditionally during driving of the vehicle 2. When the power switch is disconnected, the unconditional permission by the alternative authentication section 4c is released. When the power switch is turned on again, authentication by the authentication section 4b is required. After the power switch is turned on again, authentication by the authentication section 4b or alternative authentication by the alternative authentication section 4c is required again, enabling compliance with the contract of the billing system function, When determining that the vehicle 2 is stopped, the DCU 4 may notify, through the HCU 3 and the display apparatus 11 or the mobile terminal 9, that authentication by the authentication section 4b has failed, to immediately stop the billing system function.

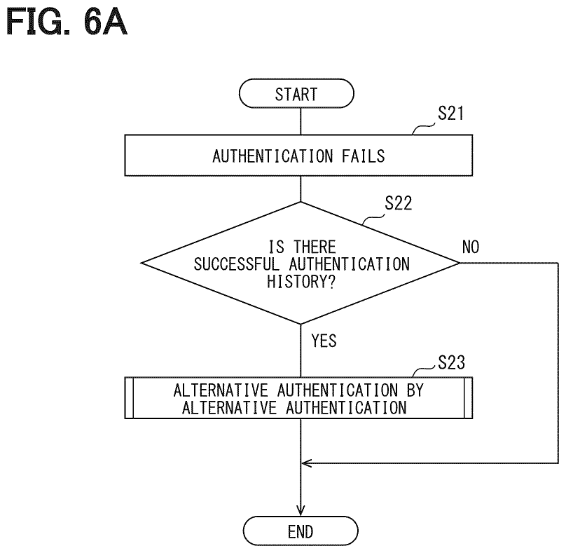

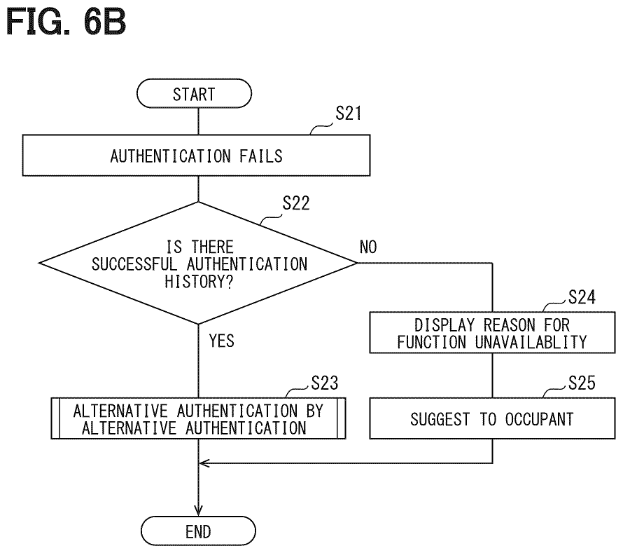

In the DCU 4, the alternative authentication section 4c may use a global positioning system (GPS) or a timer by the alternative authentication section 4c to determine whether the validity period of the billing system function has elapsed, and determine whether the billing system function is implementable. As shown in FIG. 6A, the alternative authentication section 4c may use the authentication history information of the billing system function stored in the database 4e to determine whether implementation is possible.

A case will be considered where the DCU 4 fails authentication by the authentication section 4b in S21 of FIG. 6A for the reason that a communication connection to the network 7 is unestablishable. When the alternative authentication section 4c refers to the database 4e to determine that there is a history of successful authentication going back to the past. When the alternative authentication section 4c performs alternative authentication to enable alternative authentication in S23, the target billing system function may be activated (cf. S35, S45, S56).

Conversely, when authentication by authentication by the authentication section 4b has not succeeded in the past, the DCU 4 determines NO in S22 and does not permit alternative authentication by the alternative authentication section 4c. At this time, the DCU 4 may accept only authentication by the authorized authentication section 4b. When authentication has never succeeded, the target billing system function is a function that has never been billed in the past. For this reason, alternative authentication may not be permitted. As a result, it is possible to prevent unauthorized use of the billing system function that is originally unavailable.

FIG. 6B shows a modification of FIG. 6A. When determining that there is no successful authentication history as shown in S22 of FIG. 6B, the DCU 4 may cause the display apparatus 11 to display the reason for the unavailability of the function in S24. The DCU 4 notifies the display apparatus 11 of a message via the HCU 3. As the message at this time, a reason such as “It is a function that has never been used, and is unavailable because there is no history of authentication in the past.”. The vehicle occupant is then able to understand the reason for unavailability, and support can be provided so as not to cause a sense of mistrust in the vehicle occupant. Further, in S25 of FIG. 6B, the DCU 4 may suggest billing by notifying a message such as “Will you perform billing after communication recovery?”.

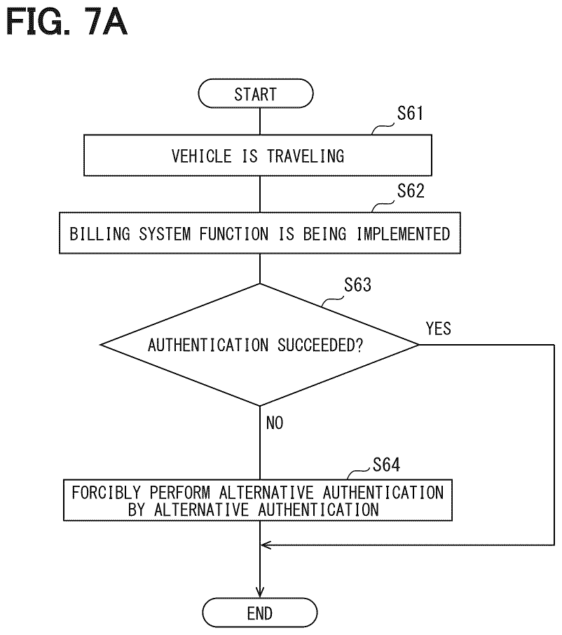

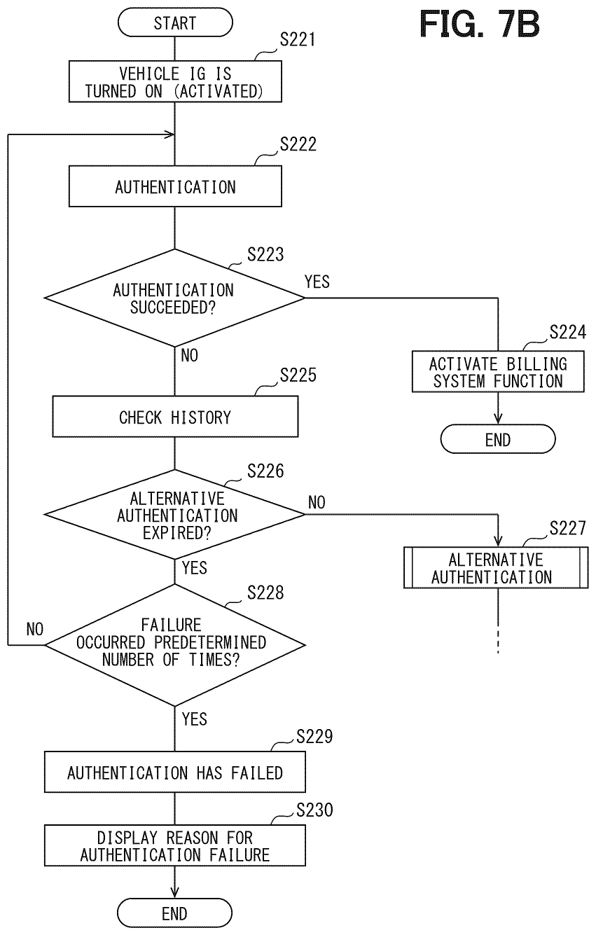

In addition, as shown in FIG. 7A, in S63, the DCU 4 may determine, by the authentication section 4b, whether the billing system function is implementable even when the vehicle 2 is traveling in S61 and the billing system function is being implemented in S62. When the determination as to whether the billing system function is implementable fails in S63, the DCU 4 may forcibly determine, by the alternative authentication section 4c, that the billing system function is implementable even during travel of the vehicle 2 in S64.

When the vehicle 2 is traveling, the DCU 4 may consider that the determination as to whether the billing system function is implementable has failed due to deterioration in the radio wave communication situation, and may forcibly permit alternative authentication by the alternative authentication section 4c to continue to activate the billing system function This enables the occupant to continue to use the target billing system function.

As described above, according to the present embodiment, when the authentication section 4b fails to determine, via the network communication section 4a, whether the billing system function is implementable as a result of communication failure with the external management server 8 and an interruption in the network connection of the billing system function, the alternative authentication section 4c performs alternative authentication. Therefore, alternative authentication can be performed even in the offline environment.

### Modification of First Embodiment

FIG. 7B shows a modification. Here, processing at the time of activation of the vehicle 2 will be described. When the ignition switch of the vehicle 2 is turned on and the vehicle 2 is activated, the DCU 4 performs authentication by the authentication section 4b in S222, and determines whether authentication has succeeded in S223. When authentication has succeeded, the DCU 4 activates the billing system function in S224, and when authentication has not succeeded, the DCU 4 checks the authentication history of the alternative authentication section 4c in S225.

Here, the DCU 4 checks the authentication history by the alternative authentication section 4c at the point when the ignition switch was last turned off. Specifically, it is checked whether the usage period of the billing system function made implementable by the alternative authentication section 4c has passed. For example, when alternative authentication by the alternative authentication section 4c is within the validity period, the DCU 4 executes alternative authentication using the alternative authentication section 4c in S227. This makes it possible to achieve the alternative function of the billing system function and improve the convenience of the occupant.

Conversely, when alternative authentication by the alternative authentication section 4c has expired in S226, the DCU 4 retries alternative authentication and repeats the retry from S222 until the number of retries exceeds a predetermined plurality of number of times in S228. When the DCU 4 determines that authentication has failed a predetermined number of times or more as a result of several retries, the DCU 4 causes the display apparatus 11 to display the reason for the authentication failure via the HCU 3 in S230. For example, the HCU 3 displays a message such as “Authentication failed at the last power-off as well, and use is unconditionally unavailable.” on the display apparatus 11 to notify the occupant of the reason for the authentication failure. This enables the occupant to understand the reason for the unavailability of the billing system function.

When the power supply of the DCU 4 is cut off while authentication by the authentication section 4b has failed, and authentication also fails at the next power-on, as shown in S223 to S230 of FIG. 7B, the DCU 4 may notify the occupant, through the HCU 3 and the display apparatus 11, that the function for which authentication by the authentication section 4b has failed is unavailable, along with the reason for the authentication failure. In this case, the occupant is able to understand the reason for the unavailability of the billing system function.

### Second Embodiment

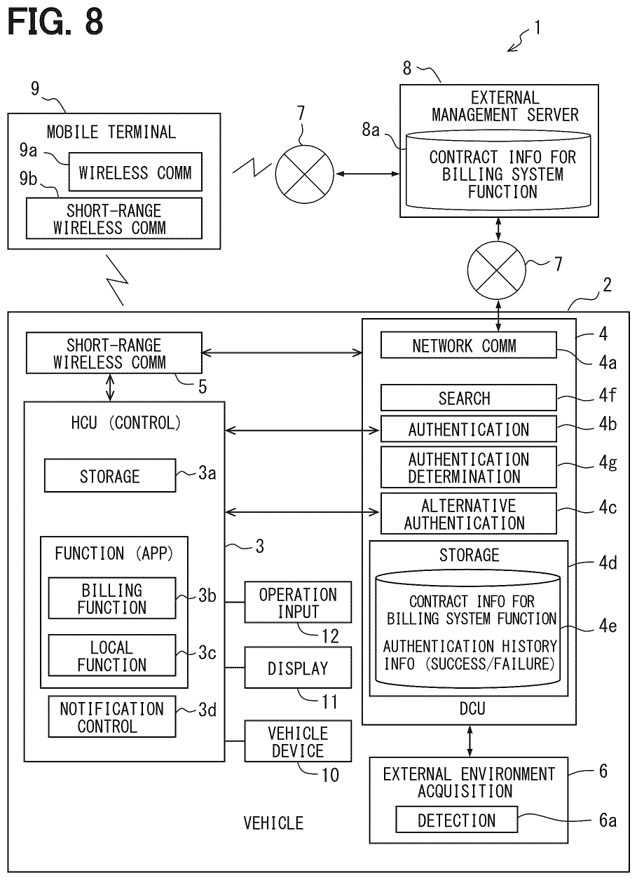

A second embodiment will be described with reference to FIGS. 8 to 10C. In the second embodiment, a form will be described in which, when the billing system function cannot be authenticated, an alternative function to substitute for the target billing system function is searched and the alternative function is executed.

In the present embodiment, as shown in FIG. 8, the DCU 4 has an application function as a search section 4f that searches for an alternative function. The DCU 4 also includes an application function as an authentication determination section 4g. Moreover, the HCU 3 includes an application function as a notification control section 3d. Other configurations are similar to those of the first embodiment, and thus the description thereof will be omitted.

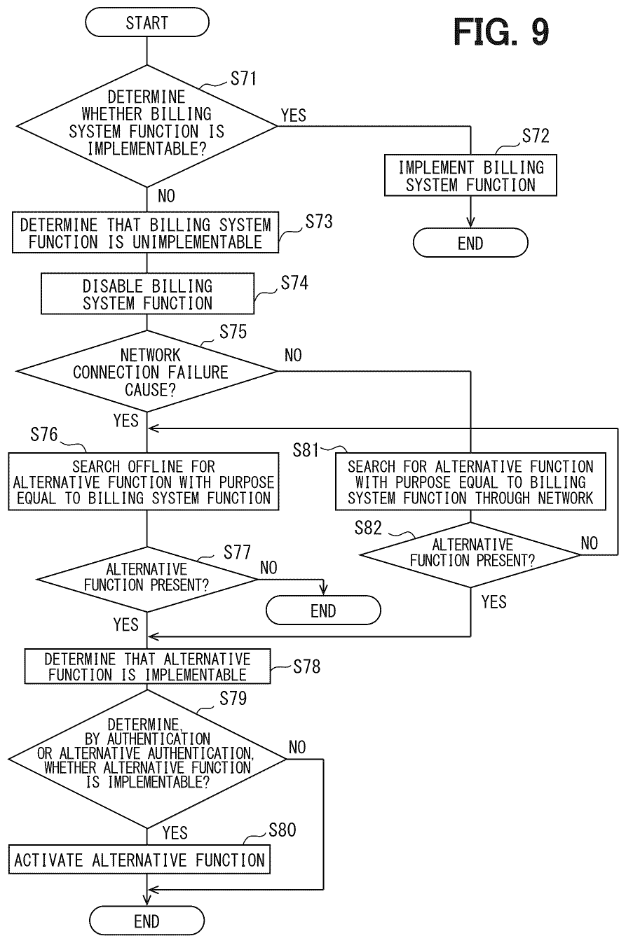

As shown in FIG. 9, in S71, the DCU 4 determines, by the authentication section 4b, whether the target billing system function is implementable via the network communication section 4a. When determining that the billing system function is implementable, the DCU 4 determines YES in S71, and implements the target billing system function in S72.

Conversely, in S71, as a result of determining whether the billing system function is implementable, when the DCU 4 determines, in S73, that the target billing system function is unimplementable, the DCU 4 disables the billing system function in S74. Thereafter, regardless of the cause of the connection impossibility to the network 7, in S76 or S81, the DCU 4 causes the search section 4f to search for an application that executes an alternative function satisfying a condition of having a usage purpose equal to that of the billing system function.

When the DCU 4 determines YES in S75 and determines, by the authentication section 4b, that the billing system function is unimplementable due to an interruption in the communication through the network 7, the DCU 4 determines that the connection is unestablishable via the network communication section 4a. In this case, in S76, the DCU 4 may cause the search section 4f to search for an application with an alternative function that is implementable in an offline state, that is, in a local environment. Here, when determining, in S75, that the cause is a network connection failure, the DCU 4 searches offline, in S76, for an application provided with an alternative function having a purpose equal to that of the billing system function.

The DCU 4 searches for an application installed in advance in the storage section 4d of the DCU 4, for example, in a local environment inside the vehicle 2. When the application provided with the alternative function is stored in the storage section 4d, the DCU 4 determines that the alternative function is implementable. At the time of offline search, the DCU 4 may search for an application installed in the storage section 3a of the HCU 3.

When the DCU 4 determines, by the authentication section 4b, that the billing system function is unimplementable due to, for example, expiration of the contract period or failure in authentication of identification information of the individual, even though connection with the external management server 8 via the network 7 has been established, NO is determined in S75. At this time, the DCU 4 may cause the search section 4f to search for an application with an alternative function, which is implementable for free or for a fee, from the external management server 8 or the like in S81.

That is, when the DCU 4 determines, in S75, that the cause is not a network connection failure but expiration of the contract period or failure in authentication of identification information of the individual, the DCU 4 searches, through the network 7, for an application provided with an alternative function having a purpose equal to that of the billing system function in S81. At the time of searching through the network 7, the DCU 4 may cause the search section 4f to search for an application from the external management server 8 or may search for an application from another server (not shown) through the network 7. This application may be a no-billing application or an application equivalent to a function stored in the storage section 4d offline.

Further, the DCU 4 may cause the search section 4f to search for an alternative function from functions provided in the mobile terminal 9 as an external terminal. The communication method at the time of search may be local communication connection through the short-range wireless communication sections 5, 9b, or communication connection via a connection server (not shown) through the network communication section 4a and the network 7.

When the connection to the network 7 is possible, and there are applications each having an equal purpose and the corresponding function, an application with a billing system function for the subscription service may be the target. In this case, the DCU 4 may determine whether the application with the billing system function for the subscription service is available.

Therefore, the application that executes the alternative function may be an application with a billing system function for the subscription service, an application with a billing system function of a one-time payment (so-called shareware), an application with a non-billing system function (so-called freeware), or the like.

As a specific application, for example, when the target billing system function under the contract is an application for driving assistance including a driving control function of the vehicle 2, such as an application having a driving assistance function related to safety or security, the DCU 4 causes the search section 4f to search for a driving control application having a purpose equal to that of the driving assistance.

When the target billing system function under contract is an application provided with a navigation function that displays a map on the display screen of the display apparatus 11 and provides guidance to the destination, the DCU 4 causes the search section 4f to search for a map display application having a different title or an application provided with another navigation function.

As the navigation function, for example, a billing system function is provided to accurately search, from the network 7, for guidance to a location where high-resolution 3D map display and various services can be provided. In addition, an alternative function is provided to perform route guidance as well as high-resolution map display even in a 2D map view. Further, a local function is provided to perform geographic guidance using only simple map display or a simple symbol. In this manner, the functions can be divided stepwise.

Even when it is difficult to authenticate the billing system function holding the contract in advance, the DCU 4 can search for an application with another function online from the network 7 through the network communication section 4a. Further, the DCU 4 can search offline for applications stored in advance in the storage sections 3a, 4d. In this manner, the function can be searched stepwise.

For example, when the HCU 3 cannot display only the map portion of the navigation function, the DCU 4 may search only for the map portion from the local storage sections 3a, 4d. At this time, the HCU 3 may read and use only the map portion searched by the DCU 4 from the storage sections 3a, 4d, and display the map portion on the display screen of the display apparatus 11.

For example, also as for an application for person authentication, the DCU 4 may search stepwise for a function of the application. For example, some person authentication applications include a billing system function with relatively high recognition accuracy, and some include a local function with low recognition accuracy. The same applies to such human recognition applications.

The DCU 4 may download and store, in the storage section 4d in advance, an application that permits implementation of the alternative function when authentication by the authentication section 4b fails. The DCU 4 can then immediately search for the alternative function permitted to be implemented by the search section 4f.

When the application with the target billing system function is an application with a comfort function related to an amusement that seeks comfort in the vehicle 2, the search section 4f searches for an application with a comfort function having an equal purpose. The DCU 4 may cause the search section 4f to search from the same category or genre. When the authentication section 4b of the DCU 4 determines that the billing system function is unimplementable, the HCU 3 may perform the application with the alternative function searched by the search section 4f of the DCU 4.

Here, a specific example of the alternative function will be further described. The alternative function of the billing system function may substitute 100% of the target billing system function or partially substitute only a part of the function. Usually, the billing system function is often higher in performance than a free application. For this reason, even when the alternative function of the billing system function is attempted to be achieved using only a free function, the possibility of 100% reproduction is low.

In the case of 100% substitution for the billing system function, the DCU 4 may search for and implement another billing application. For example, by searching for and using another audio application as another billing application, it is possible to receive radio in addition to a music playback function. The DCU 4 may use another music application when the function of the audio application becomes unavailable due to expiration of authentication. For this music application, an application capable of both music playback and radio reception may be searched.

In the case of substituting a part of the function, the following application may be searched and used: an application pre-installed in the storage section 3a of the HCU 3 or the storage section 4d of the DCU 4, a free application from the system, or an application with a usage fee of an authentication-expired billing system function or a fee lower than a predetermined fee.

In the case of substituting a part of the function, the DCU 4 may search for and use an application incapable of receiving radio with only a music playback function. When the billing system function is unavailable and the alternative function is searched, an application incapable of receiving radio with only a music playback function may be searched and used from the beginning. Alternatively, first, an audio application equipped with both a music playback function and a radio function may be searched, and thereafter, when the audio application equipped with both functions becomes unavailable due to expiration of authentication, an application incapable of receiving radio with only a music playback function may be searched and used.

In this case, when an application provided with an alternative function to be searched is an application related to safety or security, the application may be given a higher priority, other applications with lower priorities may be stopped, and applications determined to have lower priorities may be deleted (scrapped) in order to ensure memory capacity.

The DCU 4 may use a plurality of alternative functions to implement the alternative function so as to reproduce the billing system function determined to be unimplementable. At this time, the alternative function may be implemented by combining applications that can substitute a part of the function to reproduce the billing system function.

At this time, cooperation with the external mobile terminal 9 may be performed, and inter-application cooperation may be further performed. For example, the HCU 3 may hold a music reproduction function as the local function 3c so as to be implementable, the mobile terminal 9 may hold a radio reception function, and the external management server 8 may hold an audio setting function.

For example, when transmitting/receiving or mediating music content data, the DCU 4 may add-on and execute a function of transmitting/receiving applications and data existing in various locations in the system and further adjusting the applications and data. In this case, an application provided with an adjustment function may also be searched from the external mobile terminal 9, an application server, or the like.

For example, when a navigation application provided with a navigation function and an audio application are coordinated and mediated, a mediation application provided with a mediation function may be searched. The mediation function mediates between a volume adjustment function used for destination guidance by the navigation application and a volume adjustment function for music by the audio application. For example, the HCU 3 may receive the searched application from the DCU 4 and execute the mediation application along with the navigation application and the audio application. The HCU 3 can then selectively notify the vehicle interior of direction and music, enabling the occupant to comfortably acquire direction information and enjoy the music. Although the cooperation and mediation between the navigation application and the audio application have been described here, an application that enables adjustment, cooperation, and collaboration for various applications may be searched to acquire the application as an application provided with an alternative function.

When the alternative function cannot be searched by the search section 4f through the network 7 in S81, the DCU 4 may determine NO in S82 and return to S76 to search for an alternative function that is implementable in the offline state.

When an application with an alternative function is searched and the DCU 4 determines, in S78, that the alternative function is implementable, the authentication section 4b determines, in S79, whether the alternative function is implementable through the network communication section 4a. When the DCU 4 determines, by the authentication section 4b, that the application is implementable, and determines YES in S79, the DCU 4 activates the application with the alternative function in S80. Thereafter, the HCU 3 implements the application with the alternative function. The user can use the alternative function, and the convenience of the user can be improved. When the DCU 4 cannot perform online authentication using the authentication section 4b in S79, the DCU 4 may perform alternative authentication offline using the alternative authentication section 4c.

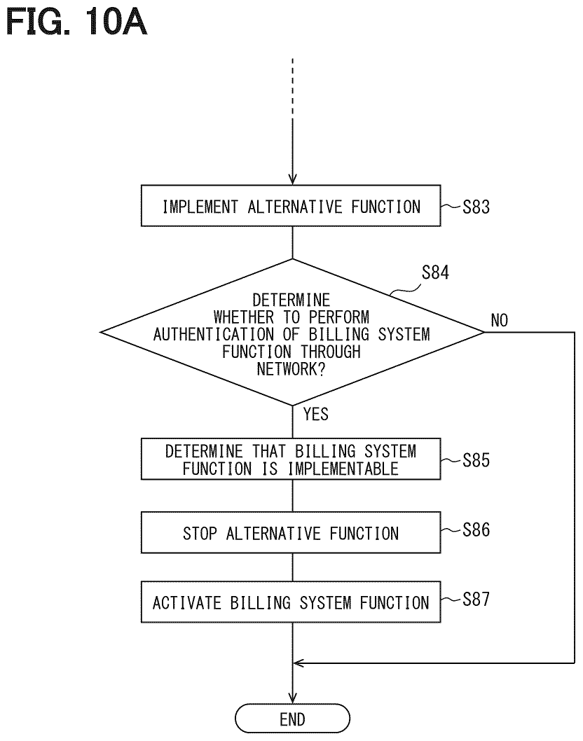

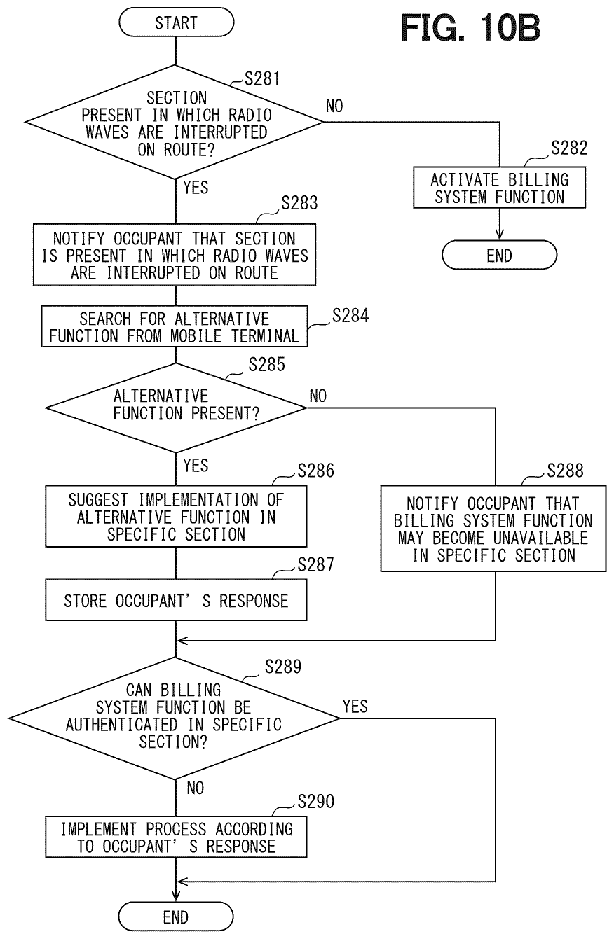

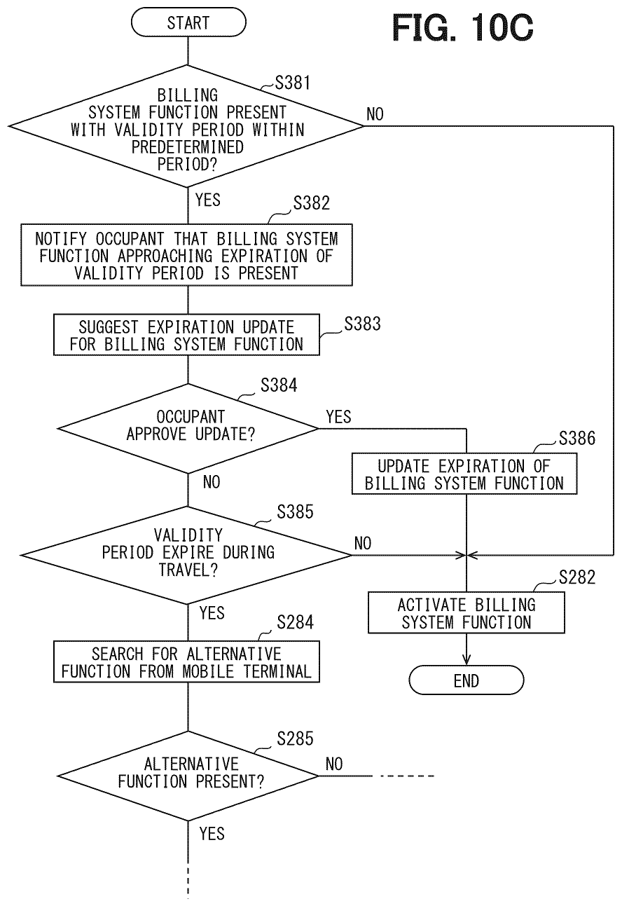

When the occupant (user) starts using the application with the alternative function, the DCU 4 executes processing shown in FIG. 10A. The DCU 4 implements the application with the alternative function searched by the search section 4f in S83. While the billing system function is being substituted by the alternative function, the occupant may be notified to be aware that the billing system function has been disabled due to expiration of authentication. Examples of this method include: (1) a method of graying out an icon for the corresponding function; (2) a method of deleting an icon for the corresponding function from the menu screen; and (3) a method of displaying information indicating that the function has been disabled on a part of the screen. The information to be displayed may be character information or a mark indicating that the function has been disabled.

The amount of information that can be displayed on the display screen of the display apparatus 11 is limited. The HCU 3 periodically checks icons to be displayed on the display apparatus 11, and when the number of icons exceeds a predetermined amount, the HCU 3 organizes the displayed information by reducing the size of the displayed information to ensure more display area, or by deleting displayed information having a lower importance level.

The HCU 3 may display link information for moving to an authentication registration site for the application with the billing system function. When the expiration of authentication for the billing system function is confirmed, the occupant can access the registration site for the billing system function using the HCU 3 or the browser function of the display apparatus 11 by selecting a link for an inquiry destination. The phone number or uniform resource locator (URL) for the inquiry destination and the QR code (registered trademark) therefor may be displayed. Even when the DCU 4 of the vehicle 2 cannot be connected to the network 7, there is a possibility that the occupant can cope with the situation by using the communication function of the mobile terminal 9 as long as information is displayed. Thus, even when the DCU 4 cannot be connected to the network 7, the occupant can access the registration site through the mobile terminal 9, and the anxiety of the occupant can be removed.

Even during implementation of the application with the alternative function searched by the search section 4f in S83, the DCU 4 may determine whether the authentication section 4b can authenticate the billing system function in S84. When the DCU 4 determines that the billing system function can be authenticated in S85, the HCU 3 may stop the implementation of the application with the alternative function in S86, and activate the billing system function in S87. The HCU 3 may prioritize the implementation of the application with the billing system function. Thus, even during implementation of the application with the alternative function, when the authentication of the application with the authorized billing system function becomes possible in the middle of the implementation, the application with the billing system function can be preferentially implemented, and the convenience of the user can be improved.

Conversely, once the HCU 3 has implemented the alternative function, a higher priority may be given to implementation of the alternative function over the billing system function for the subscription service. The DCU 4 may store the priority change in the storage section 4d and determine which function is to be implemented with reference to the priority stored in the storage section 4d. In this case, the HCU 3 may prioritize implementation of the alternative function over the billing system function.

As described above, according to the present embodiment, the DCU 4 causes the search section 4f to search for the alternative function, and even when the authentication section 4b determines that the billing system function is unimplementable, HCU 3 may implement the alternative function searched by the search section 4f. Therefore, even when the license authentication for the billing system function for the subscription service fails from inside the vehicle 2, the alternative function can be used to implement a function at the same level as the subscription service for the billing system function or a function at a minimum level required by the occupant.

Hereinafter, a modification of the second embodiment will be described with reference to FIGS. 10B and 10C.

### First Modification of Second Embodiment

A first modification of the second embodiment will be described with reference to FIG. 10B. The DCU 4 determines, by the authentication section 4b, whether the billing system function is implementable, and when there is no section in which radio waves are interrupted during execution of the navigation application (NO in S281), the DCU 4 may activate the billing system function as usual (S282). However, there is a case where the existence of a section in which radio waves are interrupted on the navigation direction route is recognized in advance (YES in S281). Here, the DCU 4 determines in advance the possibility of occurrence of a network connection failure, thereby determining in advance that the authentication for the billing system function by the authentication section 4b will become impossible.

At this time, the DCU 4 notifies the occupant in advance via the HCU 3 that there is a section in which radio waves are interrupted on the route (S283), and then searches for an alternative function from the mobile terminal 9 (S284). In S285, the DCU 4 determines whether there is an alternative function, and when there is an alternative function, the DCU 4 suggests the implementation of the alternative function to the occupant in the specific section in S286. At this time, upon receiving an operation input from the operation input section 12, the DCU 4 stores the occupant's response in the storage section 4d.

On the other hand, when determining that there is no alternative function in S285, the DCU 4 notifies the occupant, through the HCU 3 and the display apparatus 11, that there is a possibility that the billing system function becomes unavailable in the specific section in S288. When the DCU 4 determines, in S289, that the billing system function can be authenticated even when the specific section is approached, the DCU 4 exits this routine and executes the billing system function as usual. Conversely, when the DCU 4 determines, in S289, that the billing system function cannot be authenticated due to the specific section being approached, the DCU 4 implements a response according to the occupant's response stored in advance in the storage section 4d in S290.

For example, in a case where a route with radio wave interruption is set, or in a case where the validity period of the billing system function expires after 12:00 midnight, the DCU 4 can execute the billing system function as usual, as long as the billing system function can be authenticated even when the specific section described above is approached. Conversely, when the DCU 4 determines that the billing system function cannot be authenticated due to the specific section being approached, the DCU 4 implements a process according to the occupant's response stored in advance in the storage section 4d in S290. At this time, even when the billing system function becomes unimplementable, the occupant can implement the preset alternative function, and the convenience of the occupant can be improved.

### Second Modification of Second Embodiment

As shown in FIG. 10C, the processing in S381 to S386 may be executed before the alternative function is searched from the mobile terminal 9 in S284. In S381, the DCU 4 refers to the storage section 4d and determines whether a billing system function with its validity period within a predetermined period (e.g., 1 day, 2 days, 1 week, etc.) has been registered. When the validity period is set within a predetermined range in S381, the DCU 4 notifies, in S382, the occupant that there is a billing system function that is approaching expiration of the validity period, by the function of the notification control section 3d of the HCU 3. In S383, the DCU 4 suggests the expiration update for the billing system function. When the occupant approves the update, that is, does not deny the update, the DCU 4 communicates with the external management server 8 so as to update the expiration of the billing system function in S386, and stores the update in the storage section 4d.

When the route is set by the navigation function, and it is assumed that the validity period of the billing system function expires during travel, the HCU 3 searches for an alternative function from the mobile terminal 9 in S284. Since the subsequent processing is similar to the processing in S285 to S290 of FIG. 10B, the description thereof is omitted.

According to such a modification of the second embodiment, the network communication section 4a communicates, via the network 7, with the external management server 8 storing information on the billing system function that is implementable by the occupant of the vehicle 2, and the authentication section 4b determines whether the billing system function is implementable via the network communication section 4a. The authentication determination section 4g determines in advance the possibility of occurrence of at least one of a network connection failure or expiration of a validity period of the billing system function, thereby determining in advance that authentication for the billing system function by the authentication section 4b will become impossible. The notification control section 3d notifies the occupant when the authentication determination section 4g determines that authentication by the authentication section 4b will become impossible.

The DCU 4 causes the search section 4f to search for an alternative function having a usage purpose equal to that of the billing system function, and when the authentication determination section 4g determines that authentication by the authentication section 4b will become impossible due to a network connection failure, the notification control section 3d suggests the implementation of the searched alternative function. For example, when a route with radio wave interruption has been set and the possibility that a connection to the network 7 is unestablishable is determined to be high, the DCU 4 determines that the billing system function will become unavailable for a long period of time and suggests the implementation of the alternative function. Thus, even when the billing system function becomes unavailable for a long period of time, it is possible to suggest the implementation of the alternative function, which is convenient for the occupant.

When using the function of the search section 4f, the DCU 4 may add the preference of the occupant to conditions for determining the alternative function. For example, also for the audio application, the following may be searched: an application provided with an alternative function supporting heavy bass or high pitches, or an application provided with an alternative function that enhances a preference of a music genre such as J-POP or Jazz. In the navigation function, the hue of a background color may be set to pastel or vivid, the occupant may be caused to input these preferences in advance on an option screen, or learning of the audio setting input by the occupant may be performed.

Although the DCU 4 causes the search section 4f to search for the alternative function, when the DCU 4 determines that authentication by the authentication section 4b will become impossible due to expiration of the validity period of the billing system function, the notification control section 3d may suggest the extension of the billing system function to the occupant. For example, when the validity period expires due to a date change over 0:00 AM or the validity period expires during travel of the vehicle 2, the extension of the validity period of the billing system function may be suggested to the occupant. It is desirable to suggest extension of the validity period to the occupant even in a case where the validity period will expire at a relatively close date, such as within one week or within two weeks.

### Third Embodiment

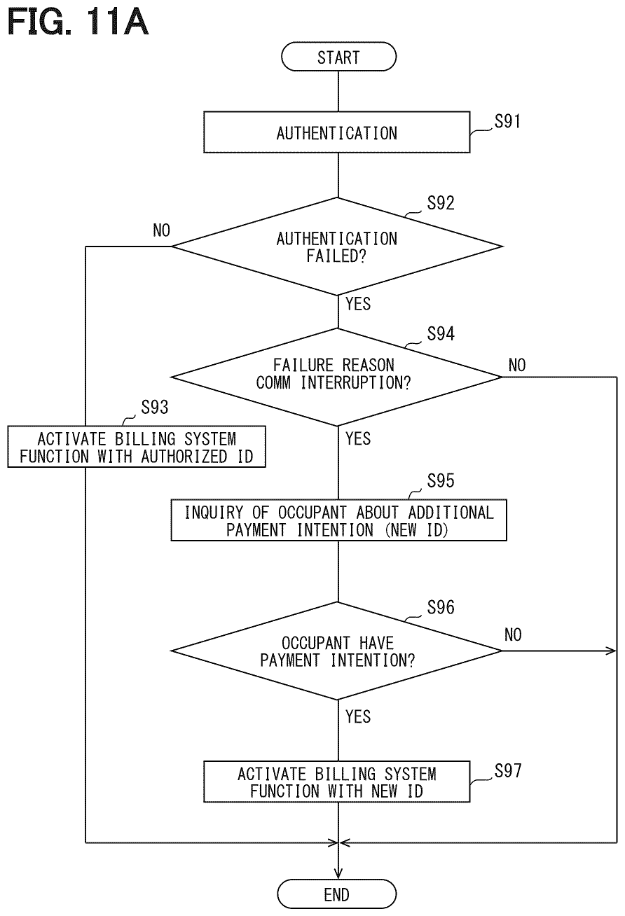

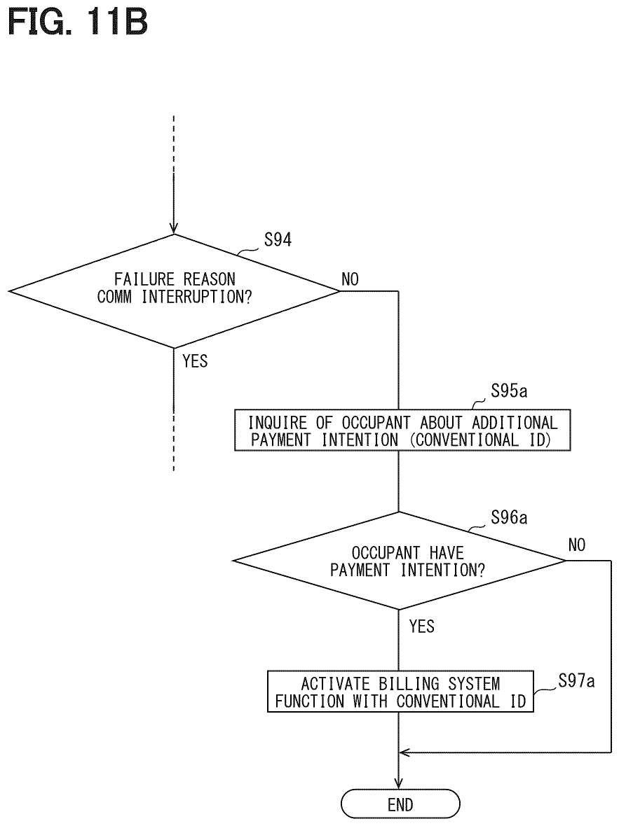

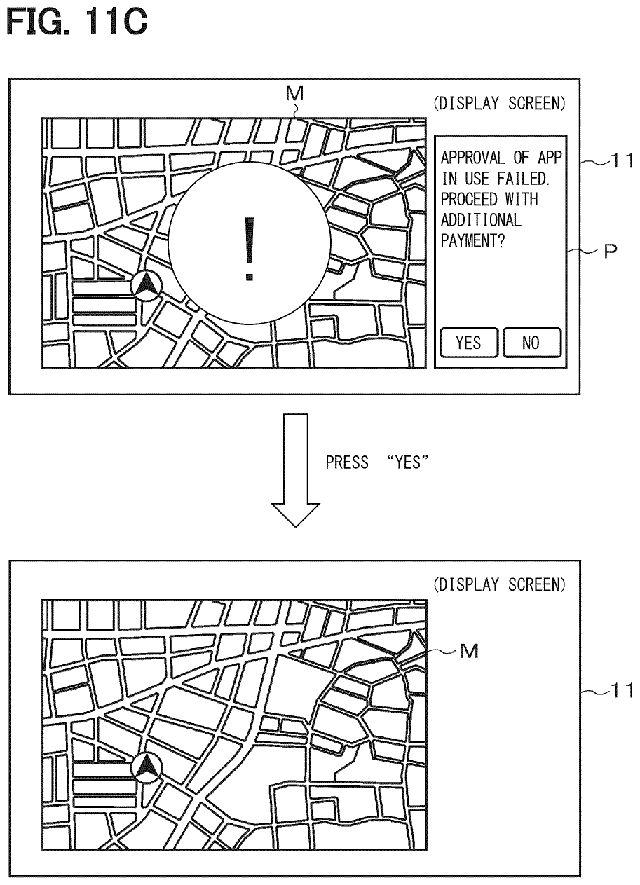

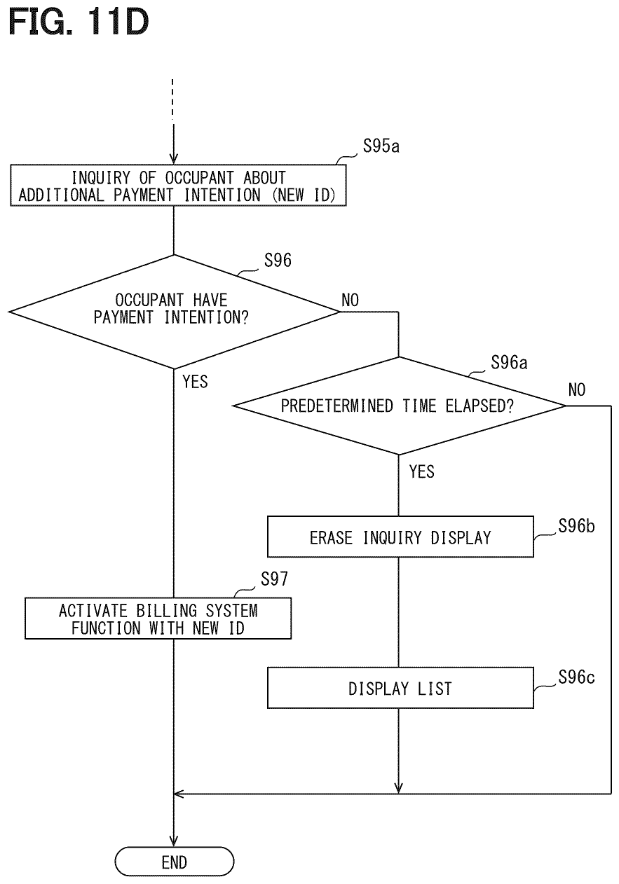

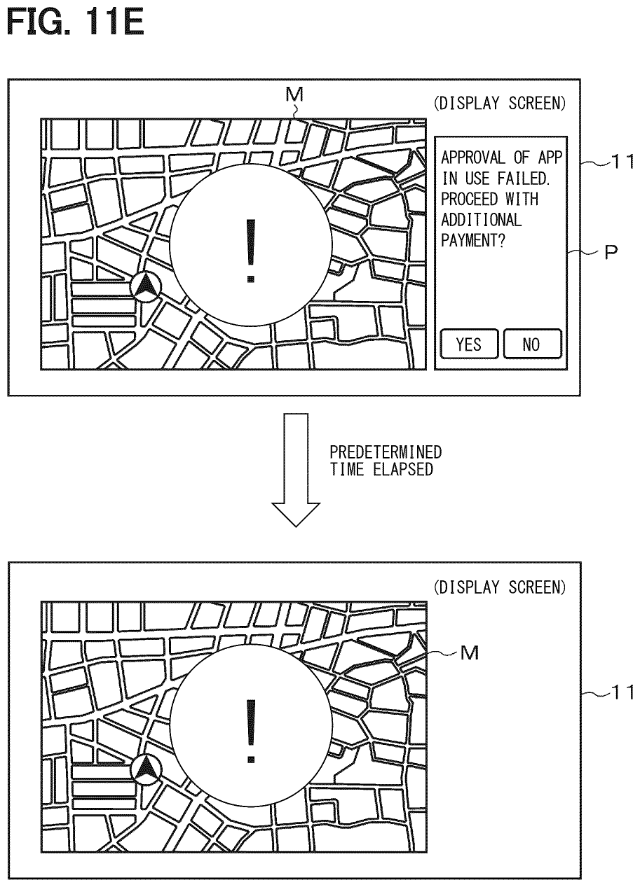

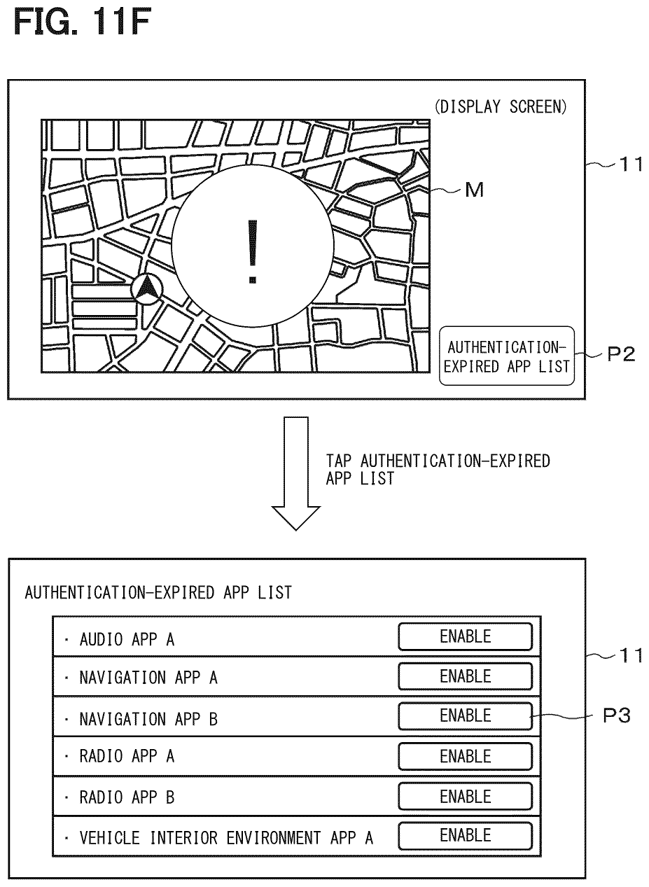

A third embodiment will be described with reference to FIGS. 11A to 13B. In the third embodiment, parts different from the first embodiment or the second embodiment will be described. As shown in FIG. 11A, the DCU 4 performs authentication through the network 7 using the authentication section 4b in S91. In S92, the DCU 4 determines whether authentication by the authentication section 4b has succeeded.

When authentication has succeeded in S92, the DCU 4 activates, in S93, the billing system function with an authenticated authorized ID (identification information of personal authentication). In this case, the user can use the billing system function as usual.

When authentication by the authentication section 4b fails in S92, the DCU 4 determines, in S94, whether the failure reason is a communication interruption caused by a deterioration in communication environment. When the communication is not interrupted, the DCU 4 determines NO in S94 and determines that the personal authentication has failed. However, when the failure reason is a communication interruption, the DCU 4, in S95, inquires of the user whether there is an additional payment intention for the corresponding billing system function, by displaying on the display apparatus 11 through the HCU 3 or by communicating with the mobile terminal 9. For example, during a trial period for one month or the like, the billing system function or another billing system function may be available for free on trial. In this case, the user may be notified of this fact and may be inquired as to whether there is an additional payment intention. When the approval operation by the operation input section 12 is not received for a predetermined time, the DCU 4 may delete the display of whether there is an additional payment intention.

As a result, the DCU 4 determines whether there is an additional payment intention in S96. Upon receiving the input for the payment intention from the operation input section 12 or the mobile terminal 9, the DCU 4 determines YES in S96 and determines that the user has an additional payment intention for the corresponding billing system function. For example, when identification information, such as a credit card number, is stored in advance in the storage sections 3a, 4d in the vehicle 2, the DCU 4 may consider that the user has an additional payment intention and automatically determine that the user has an additional payment intention.

In S97, the DCU 4 makes an additional payment from the short-range wireless communication section 5 through the mobile terminal 9 by, for example, credit card payment, and activates the billing system function using the personal authentication information of a new ID. Thereafter, the corresponding billing system function may be implemented by the HCU 3 or the like. When a certificate is stored in the mobile terminal 9, the mobile terminal 9 may transmit the certificate to the vehicle 2 to enable authentication even offline.

On the other hand, when the failure reason is not a communication interruption in S94 of FIG. 11A, the DCU 4 may exit the routine, as shown in FIG. 11A. However, as shown in S95a of FIG. 11B, the DCU 4 may inquire of the occupant whether to add a payment intention in association with a conventional ID that already exists. When the occupant shows a payment intention in S96a, the DCU 4 may activate the billing system function with the conventional ID in S97a.

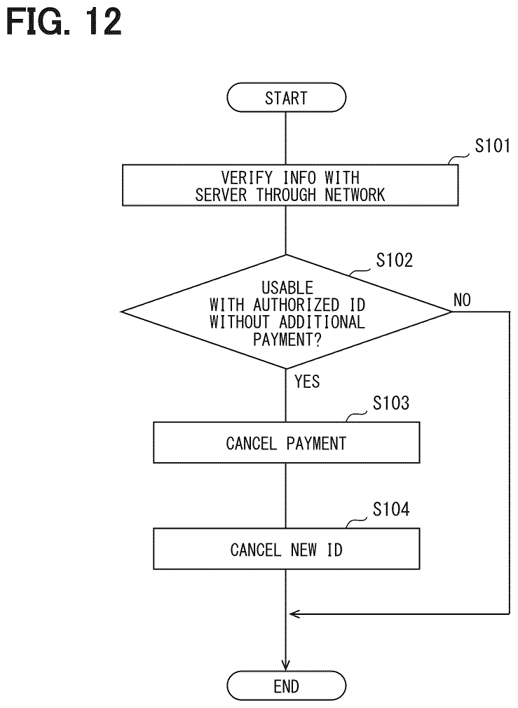

Even when it is determined that the occupant has a payment intention and the HCU 3 is implementing the corresponding billing system function, the DCU 4 performs online authentication via the network communication section 4a in S101 of FIG. 12. When the communication environment of the network 7 becomes favorable, the DCU 4 verifies information stored in the database 8a of the external management server 8 in S101.

In S102, the DCU 4 determines whether the corresponding billing system function is usable without additional payment. When the DCU 4 determines, in S102, that the function is usable without additional payment, the DCU 4 may, in S103, cancel the additional payment for the corresponding billing system function and cancel the determination of the additional payment intention made by the occupant. Moreover, the new ID may be canceled in S104. Cancellation of the new ID is optional, and the new ID may be canceled after the cancellation intention of the occupant is confirmed. Thereafter, the HCU 3 can implement the corresponding billing system function using the existing authorized ID. As a result, the occupant can effectively use the billing system function based on the existing regular ID. In addition, for example, a period during which the function was used after an additional payment may be compared with the additional payment and a validity period before expiration of authentication, and when the period falls outside the validity period, an additional payment may be caused to be made.

When YES is determined in S102 and, for example, a double payment is determined, the DCU 4 may perform a refund process. When the payment is canceled in S103 and a new ID deletion process is performed in S104, this fact may be notified to the occupant through the display apparatus 11. The message at this time is, for example, “Due to a double payment, a refund process will be performed.” or “No additional payment was made because a payment had already been made. This function is running without an additional payment.”. In this case, the occupant can confirm whether a payment has been made unnecessarily, whether a refund has been made after the payment, or whether no payment has been made in the first place, and the occupant can be prevented from feeling anxiety.

### First Modification

### (Button Operation by Occupant and Display Screen Content of Display Apparatus 11 During Vehicle Stop, Automated Driving, or Vehicle Travel)

For example, when the reason for the failure of authentication by the authentication section 4b is a communication interruption in S94 of FIG. 11A, the occupant is additionally inquired about a payment intention. Even when the reason for the failure of authentication by the authentication section 4b is not due to a communication interruption in S94 of FIG. 11B, the occupant is additionally inquired about a payment intention in S95a.

For example, as shown in FIG. 11C, the HCU 3 shows an inquiry display P on the display screen of the display apparatus 11 to prompt the occupant to perform an operation input. For example, in the example shown in FIG. 11C, a message such as “Approval of the application in use failed. Proceed with additional payment? (Yes/No)” is displayed to prompt an operation input. At the same time, the HCU 3 issues a warning by displaying an exclamation mark at the center of a map screen M during operation of the navigation application, and draws the occupant's attention to the inquiry display P. In this case, some kind of operation input by the operation input section 12 is required.

When the predetermined button “Yes” is pressed by the occupant through the operation input section 12 during stopping, automated driving, or manual driving of the vehicle 2, the HCU 3 causes an additional payment to be made, activates the billing system function, and then deletes the inquiry display P from the display screen, as shown in FIG. 11C.

Further, during manual driving or the like of the vehicle 2, a predetermined button “YES” may not be pressed by the occupant through the operation input section 12. In this case, the processing routine shown in FIG. 11A cannot activate the billing system function for a long time. In such a case, as shown in S96a to S96c of FIG. 11D, the HCU 3 may delete the inquiry display P when determining that the operation input section 12 receives no operation instruction for a predetermined time. FIG. 11E shows an example of this screen transition.

When no operation input for a payment intention is performed even after the lapse of a predetermined time, a list of expired billing system functions may be notified on the display screen of the display apparatus 11 by pop-up in S96c of FIG. 11D. An example of the screen at this time is shown in FIG. 11F. As shown in the upper portion of FIG. 11F, the HCU 3 may display an inquiry display P2 of an “authentication-expired application list” button while leaving the warning display of the exclamation mark on the map screen M, thereby temporarily prompting the occupant to perform an operation input. When the HCU 3 detects an operation input has been performed on the inquiry display P2 for the authentication-expired application list, the DCU 4 refers to the database 4e, and the HCU 3 selects expired billing system functions stored in the database 4e and displays the selected functions on the display screen. See the lower portion of FIG. 11F.

When the operation input for the payment intention is not performed even after the lapse of the predetermined time, the HCU 3 may directly display the authentication-expired application list on the display screen of the display apparatus 11, as shown in the lower portion of FIG. 11F, without displaying the inquiry display P2 for the authentication-expired application list, as shown in the upper portion of FIG. 11F.

The HCU 3 may cause the occupant to selectively determine whether the billing system function is necessary. At this time, the HCU 3 may display an inquiry display P3 indicating “enable”, and when the inquiry display P3 is pressed, the billing system function may be selectively enabled, that is, activated. Here, a billed period and billing history information may be displayed for each billing system function.

### Second Modification

### (Payment Intention Display and Display Screen Content of Display Apparatus 11 Particularly During Travel of Vehicle)

It is particularly difficult for the driver to show an additional payment intention during travel of the vehicle by manual driving or the like. For example, when the DCU 4 requires a detailed inquiry when making an inquiry to the occupant regarding an additional payment intention, a plurality of operation inputs may be required.

This is, for example, a case where a number, a setting button, or the like is operated and input at least two or more times in succession for card number information and a validity period of a credit card (billing method), and billing conditions, such as a validity period and the number of times of validity, necessary for adding the billing system function. The billing method here represents information such as a card number and a validity period of a credit card. Examples of the billing conditions include a billing period condition in units of one day, one week, one month, three months, six months, or one year, and a number-of-times condition, such as one time or three times during activation of the vehicle 2. In such cases, it is undesirable for the occupant in the vehicle 2, particularly the driver, to perform an operation input many times. Therefore, all the authentication may be performed by receiving a single button operation input.

The operation button of the operation input section 12 at this time may be an icon displayed on the display screen of the display apparatus 11 or a physical button installed on a steering wheel or the like. In the case of the icon, the icon is not displayed on the normal display screen of the display apparatus 11. The HCU 3 displays the icon on the display screen only in an emergency, and the occupant taps the icon to receive an operation input through the touch panel. In particular, the icon may be configured to be displayed only “when the occupant is required to perform an operation in an emergency during travel”.

Further, for example, the physical button installed around the steering wheel is not assigned that function under normal circumstances. The HCU 3 may display the role of the physical button on the display screen of the display apparatus 11 only when requesting the occupant to perform an operation during travel in an emergency, and may determine the payment intention by using the result of pressing the physical button as the operation input result of the operation input section 12.

In particular, when an approval is requested in an emergency, an operation input using the physical button or the icon may be received on condition that authentication by the authentication section 4b has already expired. This eliminates the need to separately prepare a billing confirmation button. Thus, for example, when the condition of S94 of FIG. 11A is satisfied at the time of the operation input of the physical button or the icon, the processing in S95 and S96 can be omitted, and the billing system function can be immediately activated in S97. For example, when it is determined that the condition of S94 of FIG. 11B is not satisfied, the processing in S95a and S96a can be omitted, and the billing system function can be immediately activated in S97a.

By presetting various types of authentication, the payment intention, including the billing method and the billing condition described above, may be preset in the storage section 3a or the storage section 4d of the DCU 4 through the HCU 3. Alternatively, the payment intention, including the billing method and the billing condition, may be preset in the mobile terminal 9. For example, the HCU 3 may display an option setting screen and cause the occupant to perform an operation input for the billing method and the billing condition from the operation input section 12. The mobile terminal 9 may display an option setting screen on the display screen to cause the occupant to perform an operation input for the billing method and the billing condition.

As described above, when the payment intention is stored in advance in the storage sections 3a, 4d, or the mobile terminal 9, the DCU 4 can refer to the information of the payment intention through the local or network 7 and determine that there is a payment intention without performing various types of authentication. Also in this case, as long as the payment intention is preset in the storage sections 3a, 4d, or the mobile terminal 9, for example, when the condition of S94 of FIG. 11A is satisfied, the processing in S95 and S96 can be omitted, and the billing system function can be immediately activated in S97. Further, for example, when it is determined that the condition of S94 of FIG. 11B is not satisfied, the processing in S95a and S96a can be omitted, and the billing system function can be immediately activated in S97a.

### Third Modification

The DCU 4 may determine whether the occupant has an additional payment intention for the corresponding billing system function not only when online authentication by the authentication section 4b fails, but also when offline alternative authentication by the alternative authentication section 4c fails.

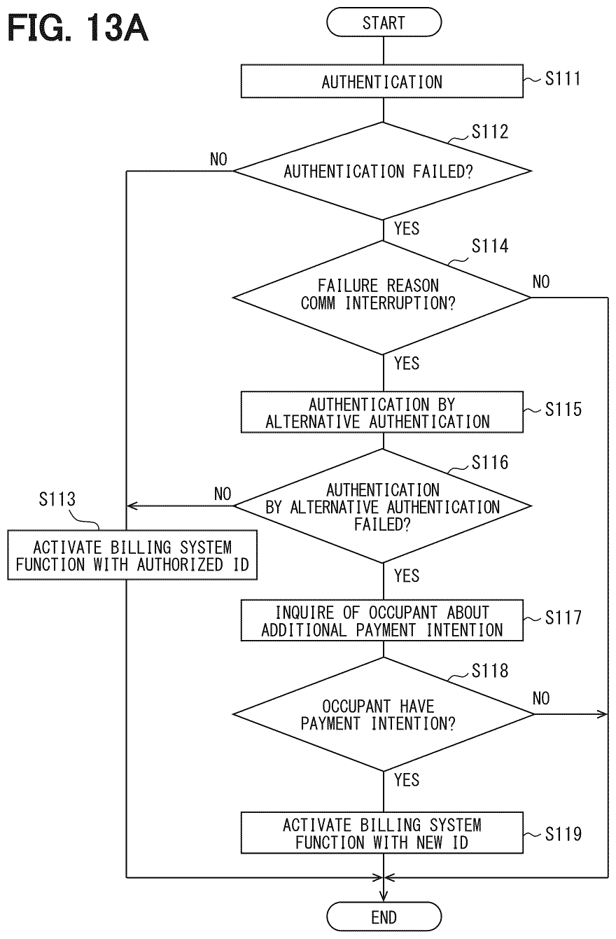

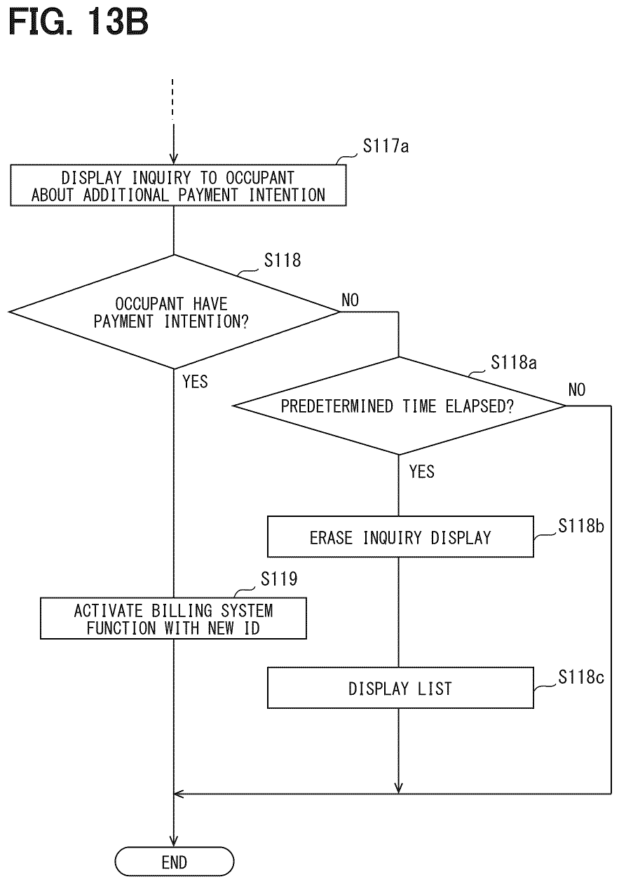

As shown in FIG. 13A, in S111, the DCU 4 performs authentication through the network 7 using the authentication section 4b. In S112, the DCU 4 determines whether authentication by the authentication section 4b has succeeded.

When authentication has succeeded in S112, the DCU 4 activates, in S113, the billing system function with an authenticated authorized ID (identification information of personal authentication). In this case, the user can use the billing system function as usual.

When authentication by the authentication section 4b fails in S112, the DCU 4 determines, in S114, whether the failure reason is a communication interruption caused by a deterioration in communication environment. When the communication is not interrupted, the DCU 4 determines NO in S114, determines that the personal authentication has failed, and exits the routine. However, when the failure reason is a communication interruption, the DCU 4 causes the alternative authentication section 4c to substitute for the authentication by the authentication section 4b in S115. When authentication by the alternative authentication section 4c fails, the DCU 4 inquires of the user whether there is an additional payment intention for the corresponding billing system function in S117.

In this case, the DCU 4 may make an inquiry from the mobile terminal 9 using the communication of the short-range wireless communication section 5, thereby determining whether there is an additional payment intention in S118. Upon receiving the input for the payment intention from the mobile terminal 9, the DCU 4 determines YES in S118 and determines that the user has an additional payment intention for the corresponding billing system function. In S119, the DCU 4 makes an additional payment using, for example, credit card payment or the like, and activates the billing system function using a new ID (personal authentication information). Thereafter, the corresponding billing system function may be implemented by the HCU 3 or the like. Further, as shown in FIG. 13B, when a payment intention is not shown even after the lapse of a predetermined time in S118a, the DCU 4 may delete the inquiry display P in S118b and display a list of expired billing system functions in S118c. Alternatively, processing similar to the processing described in (First Modification) may be executed.

As described above, according to the present embodiment, when authentication by the authentication section 4b fails, the DCU 4 determines whether the occupant has an additional payment intention for the corresponding billing system function. When determining that the occupant has an additional payment intention for the corresponding billing system function, the DCU 4 makes the corresponding billing system function implementable. Therefore, it is possible to meet the demand of the occupant and improve the convenience of the user.

### Other Embodiments

The present disclosure is not limited to the embodiments described above but can be implemented in various variations and can be applied to various embodiments without departing from the gist thereof.

In the embodiment described above, a form has been shown in which the DCU 4 mainly executes the authentication processing, but some or all of the processes and functions may be executed by another on-vehicle device (e.g., the HCU 3). Conversely, the function mounted in the HCU 3. may be executed by another on-vehicle device (e.g., the DCU 4).

The method performed using the HCU 3 or another DCU 4 according to the present disclosure may be achieved by a dedicated computer provided by configuring a processor and a memory programmed to execute one or more functions embodied by a computer program. Alternatively, the method performed using the HCU 3 and the DCU 4 according to the present disclosure may be achieved by a dedicated computer provided by configuring a processor by one or more dedicated hardware logic circuits. Alternatively, the control apparatus and the method thereof according to the present disclosure may be achieved by one or more dedicated computers configured by a combination of a processor and a memory programmed to execute one or more functions and a processor configured by one or more hardware logic circuits. The computer program may be stored in a computer-readable non-transitional tangible recording medium as an instruction to be executed by the computer.

The processing may be performed by combining the technologies of the functions in the embodiments, or the processing may be performed by combining the technologies between the embodiments.

Among them, according to a first aspect of the present disclosure, the following disclosure is also included in addition to the description of the disclosure.

(11)

A vehicle authentication system includes:
a network communication section that communicates via a network with a server storing information on a billing system function implementable by an occupant of a vehicle;
an authentication section that authenticates, through the network communication section, whether the billing system function is implementable; and
an alternative authentication section that substitutes for authentication by the authentication section when connection to the server is unestablishable through the network communication section, and
the alternative authentication section performs alternative authentication when the authentication section fails to determine, via the network communication section, whether the billing system function is implementable as a result of interruption of the connection with the server.
   (12)

In the vehicle authentication system according to (11), when the billing system function, for which implementability is to be determined, is applicable to at least one of the following: a function necessary for travel of the vehicle, a function necessary for safety of the occupant, or a function for making an internal environment of the vehicle comfortable, the alternative authentication section determines that the billing system function is implementable and performs alternative authentication.

(13)

The vehicle authentication system according to (11) or (12) further includes an external environment acquisition section that acquires external environment information of the vehicle, and when determining whether a comfort function for making an internal environment of the vehicle comfortable is implementable, the alternative authentication section performs alternative authentication by adding the external environment information of the vehicle to a condition for determining whether the billing system function is implementable.

(14)

In the vehicle authentication system according to any one of (11) to (13), when the vehicle is traveling and the authentication section fails to determine whether the billing system function is implementable while the billing system function is being implemented, the alternative authentication section determines that the billing system function is implementable.

(15)

The vehicle authentication system according to any one of (11) to (14), further includes a notification control section that notifies the occupant, and when the alternative authentication section determines whether the billing system function is implementable through alternative authentication, the notification control section controls notification to the occupant of a determination result by the alternative authentication section as to whether the billing system function is implementable.

(16)

In the vehicle authentication system according to any one of (11) to (15), the determination result by the alternative authentication section as to whether the billing system function is implementable is kept valid until authentication by the authentication section becomes possible, or until the vehicle stops and a power supply of the vehicle is turned off while authentication by the authentication section remains impossible.

(17)

The vehicle authentication system according to (16) further includes a notification control section that notifies the occupant, and in a case where the power supply is disconnected while authentication by the authentication section remains in failure, and authentication also fails when the power supply is turned on next time, the notification control section notifies the occupant that a function for which authentication by the authentication section has failed is unavailable.

(18)

The vehicle authentication system according to any one of (11) to (17), further includes an authentication history information storage section that stores authentication history information of the billing system function, and the alternative authentication section uses authentication history information of the billing system function to determine whether implementation is possible.

(19)

A vehicle authentication method includes steps of:
communicating via a network, by a network communication section, with a server storing information on a billing system function implementable by an occupant of a vehicle;
authenticating, by an authentication section, whether the billing system function is implementable through the network communication section; and
substituting, by an alternative authentication section, for authentication by the authentication section when connection to the server is unestablishable through the network communication section,
in which the alternative authentication section performs alternative authentication when the authentication section fails to determine, via the network communication section, whether the billing system function is implementable as a result of an interruption in the connection with the server.
   (20)

A vehicle authentication program causes a vehicle authentication system to execute procedures of:
communicating via a network, by a network communication section with a server storing information on a billing system function implementable by an occupant of a vehicle;
authenticating by an authentication section, whether the billing system function is implementable through the network communication section;
substituting, by an alternative authentication section, for authentication by the authentication section when connection to the server is unestablishable through the network communication section; and
performing, by the alternative authentication section, alternative authentication when the authentication section fails to determine, via the network communication section, whether the billing system function is implementable as a result of an interruption in the connection with the network.

According to a second aspect of the present disclosure, the following disclosure is also included in addition to the description of the disclosure.

(21)

A vehicle control system includes:
a network communication section that communicates via a network with a server storing information on a billing system function that is implementable by an occupant of a vehicle;
an authentication section that determines, via the network communication section, whether the billing system is implementable;
a search section that searches for an alternative function having a usage purpose equal to a usage purpose of the billing system function; and
a control section that implements the searched alternative function when the authentication section determines that the billing system function is unimplementable.
   (22)

In the vehicle control system according to (21), when the authentication section determines that the billing system function is unimplementable due to an interruption in the communication through the network, the search section searches for the alternative function implementable in an offline state.

(23)

In the vehicle control system according to (21) or (22), when the authentication section determines that the billing system function is unimplementable even though connection with the server via the network has been established, the search section searches for the alternative function implementable through the server.

(24)

In the vehicle control system according to any one of (21) to (23), the search section searches for the alternative function implementable in an offline state when the alternative function is unsearchable through the network.

(25)

In the vehicle control system according to any one of (21) to (24), the authentication section also determines whether the alternative function is implementable, and the control section implements the alternative function when the authentication section determines that the alternative function is implementable.

(26)

In the vehicle control system according to any one of (21) to (25), the search section searches for the alternative function from functions provided in an external terminal.

(27)

In the vehicle control system according to any one of (21) to (26), the control section uses a plurality of the alternative functions and implements the alternative function so as to reproduce the billing system function determined to be unimplementable.

(28)

In the vehicle control system according to any one of (21) to (27), when the billing system function by the authentication section becomes implementable during implementation of the alternative function, the control section stops implementing the alternative function and prioritizes implementation of the billing system function.

(29)

In the vehicle control system according to any one of (21) to (28), when the alternative function is implemented, a higher priority is given to implementation of the alternative function over the billing system function, and the control section prioritizes implementation of the alternative function over the billing system function.

(30)

A vehicle control system includes:
a network communication section that communicates via a network with a server storing information on a billing system function that is implementable by an occupant of a vehicle;
an authentication section that determines, via the network communication section, whether the billing system function is implementable; and
an authentication determination section that determines in advance that authentication for the billing system function by the authentication section becomes impossible by determining in advance a possibility of occurrence of at least one of a network connection failure and a validity period of the billing system function, and
a notification control section notifies an occupant when the authentication determination section determines that authentication by the authentication section becomes impossible.
   (31)

The vehicle control system according to (30) further includes a search section that searches for an alternative function having a usage purpose equal to a usage purpose of the billing system function, and the notification control section suggests implementation of the searched alternative function when the authentication determination section determines that authentication by the authentication section becomes impossible due to a network connection failure.

(32)

In the vehicle control system according to (31), the search section adds a preference of an occupant to a condition for determining the alternative function.

(33)

The vehicle control system according to any one of (30) to (32) further includes a search section that searches for an alternative function having a usage purpose equal to a usage purpose of the billing system function, and when the authentication determination section determines that authentication by the authentication section becomes impossible due to expiration of the validity period of the billing system function, the notification control section suggests an extension of the billing system function to the occupant.

(34)

A vehicle control method includes:
communicating via a network, by a network communication section, with a server storing information on a billing system function implementable by an occupant of a vehicle;
determining, by an authentication section, whether the billing system function is implementable via the network communication section;
searching, by a search section, for an alternative function having a usage purpose equal to a usage purpose of the billing system function; and
implementing, by a control section, the searched alternative function when the authentication section determines that the billing system function is unimplementable.
   (35)

A vehicle control program causes a vehicle control system to execute procedures of:
communicating via a network, by a network communication section, with a server storing information on a billing system function implementable by an occupant of a vehicle;
determining, by an authentication section, whether the billing system function is implementable via the network communication section;
searching, by a search section, for an alternative function having a usage purpose equal to a usage purpose of the billing system function; and
implementing, by a control section, the searched alternative function when the authentication section determines that the billing system function is unimplementable.

According to a third aspect of the present disclosure, the following disclosure is also included in addition to the description of the disclosure.

(41)

A vehicle control system includes:
a network communication section that communicates via a network with a server storing information on a billing system function that is implementable by an occupant of a vehicle;
an authentication section that determines, via the network communication section, whether the billing system function is implementable; and
a control section that makes the billing system function implementable; and
when authentication by the authentication section fails, a determination is made as to whether the occupant has an additional payment intention for a corresponding billing system function, and when the occupant is determined to have an additional payment intention for the corresponding billing system, the control section makes the corresponding billing system function implementable.
   (42)

In the vehicle control system according to (41), when the authentication section determines that the occupant has a payment intention, and the corresponding billing system function is being implemented, the control section performs online authentication via the network communication section and verifies information stored in the server, and when determining that the corresponding billing system function is usable without additional payment, the control section cancels an additional payment for the corresponding billing system function and implements the corresponding billing system function.

(43)

The vehicle control system according to claim (41) or (42), further includes an operation input section that receives an approval operation indicating that the occupant has an additional payment intention.

(44)

The vehicle control system according to any one of (41) to (43), further includes a notification control section that displays whether there is the additional payment intention, and when the approval operation is unreceived by the operation input section for a predetermined time, the notification control section deletes the display of whether there is an additional payment intention.

(45)

In the vehicle control system according to any one of (41) to (44), the notification control section displays, by pop-up, a list of cases where the approval operation has been unreceived by the operation input section or a list of expired billing system functions.

(46)

A vehicle control system includes:
a network communication section that communicates via a network with a server storing information on a billing system function that is implementable by an occupant of a vehicle;
an authentication section that determines, via the network communication section, whether the billing system function is implementable;
a control section that makes the billing system function implementable; and
an alternative authentication section that substitutes for authentication by the authentication section when authentication by the authentication section fails,
in which, when alternative authentication by the alternative authentication section fails, the alternative authentication section determines whether the occupant has an additional payment intention for a corresponding billing system function, and when the occupant is determined to have an additional payment intention for the corresponding billing system, the control section makes the corresponding billing system function implementable.
   (47)

A vehicle control method includes:
communicating via a network, by a network communication section, with a server storing information on a billing system function implementable by an occupant of a vehicle;
determining, by an authentication section, whether the billing system function is implementable via the network communication section; and
implementing, by a control section, the billing system function, and
when authentication by the authentication section fails, the authentication section determines whether the occupant has an additional payment intention for a corresponding billing system function, and when the occupant is determined to have an additional payment intention for the corresponding billing system function, the control section makes the corresponding billing system function implementable.
   (48)

A vehicle control program causes a vehicle control system to execute procedures of:
communicating via a network, by a network communication section, with a server storing information on a billing system function implementable by an occupant of a vehicle;
determining, by an authentication section, whether the billing system function is implementable via the network communication section; and
implementing, by a control section, the billing system function, and
when authentication by the authentication section fails, the authentication section determines whether the occupant has an additional payment intention for a corresponding billing system function, and when the occupant is determined to have an additional payment intention for the corresponding billing system function, the control section makes the corresponding billing system function implementable.

What is claimed is:

1. A vehicle authentication system comprising:
at least one of (i) a circuit and (ii) a processor with a memory storing computer program code executable by the processor, the at least one of the circuit and the processor configured to cause the vehicle authentication system to:
communicate via a network with a server storing information regarding billing system function executable by an occupant of a vehicle;
authenticate whether the billing system function can be enabled; and
substitute for authentication when connection to the server cannot be established,
wherein
alternative authentication is performed when, as a result of a disconnection from the server, the vehicle authentication system fails to determine whether the billing system function can be enabled.

2. The vehicle authentication system according to claim 1, wherein
a network communication section is implemented by the at least one of (i) the circuit and (ii) the processor with the memory storing computer program code executable by the processor configured to communicate via the network with the server storing the information regarding the billing system function executable by the occupant of the vehicle;
an authentication section is implemented by the at least one of (i) the circuit and (ii) the processor with the memory storing computer program code executable by the processor configured to authenticate, via the network communication section, whether the billing system function can be enabled; and
an alternative authentication section is implemented by the at least one of (i) the circuit and (ii) the processor with the memory storing computer program code executable by the processor configured to substitute for the authentication by the authentication section when the connection to the server cannot be established via the network communication section,
wherein
the alternative authentication section performs the alternative authentication when, as the result of the disconnection from the server, the authentication section fails to determine, via the network communication section, whether the billing system function can be enabled.

3. The vehicle authentication system according to claim 2, wherein
the alternative authentication section determines that the billing system function can be enabled and performs the alternative authentication when the billing system function to be determined for availability corresponds to at least one of: a function necessary for travel of the vehicle, a function necessary for a safety of the occupant, and a function for making an internal environment of a vehicle comfortable.

4. The vehicle authentication system according to claim 2, wherein
the at least one of (i) the circuit and (ii) the processor with the memory storing computer program code executable by the processor is further configured to implement
an external environment acquisition section configured to acquire external environment information of the vehicle,
wherein
when determining whether a comfort function for making an internal environment of a vehicle comfortable can be enabled, the alternative authentication section performs alternative authentication by adding the external environment information of the vehicle to a determination condition for enabling the billing system function.

5. The vehicle authentication system according to claim 2, wherein
when the vehicle is traveling and, during execution of the billing system function, the authentication section fails to determine whether the billing system function can be enabled, the alternative authentication section determines that the billing system function can be enabled.

6. The vehicle authentication system according to claim 2, wherein
the at least one of (i) the circuit and (ii) the processor with the memory storing computer program code executable by the processor is further configured to implement
a notification control section configured to provide notification to the occupant,
wherein
when the alternative authentication section determines whether the billing system function can be enabled, the notification control section controls notification to the occupant of a determination result by the alternative authentication section regarding whether the billing system function can be enabled.

7. The vehicle authentication system according to claim 2, wherein
the alternative authentication section determines whether the billing system function can be enabled by alternative authentication, and
a determination result by the alternative authentication section remains valid until authentication by the authentication section becomes possible, or until the vehicle stops and a power supply of the vehicle is turned off while authentication by the authentication section remains impossible.

8. The vehicle authentication system according to claim 7, wherein
the at least one of (i) the circuit and (ii) the processor with the memory storing computer program code executable by the processor is further configured to implement
a notification control section configured to provide notification to the occupant,
wherein
when the power supply is turned off while authentication by the authentication section has failed and authentication also fails when the power supply is next turned on, the notification control section notifies the occupant that the function for which authentication by the authentication section failed is unavailable.

9. The vehicle authentication system according to claim 2, wherein
the vehicle further includes an authentication history information storage section that stores authentication history information of the billing system function, and
the alternative authentication section uses the authentication history information of the billing system function in determining whether the billing system function can be enabled.

10. A vehicle authentication method comprising:
communicating, by a network communication section, via a network with a server that stores information regarding billing system functions executable by an occupant of a vehicle;
authenticating, by an authentication section, whether the billing system function can be enabled via the network communication section; and
substituting, by an alternative authentication section, for authentication by the authentication section when connection to the server cannot be established via the network communication section,
wherein
the alternative authentication section performs alternative authentication when, as a result of a disconnection from the server, the authentication section fails to determine, via the network communication section, whether the billing system function can be enabled.

11. A non-transitory computer readable storage medium storing a vehicle authentication program for causing a vehicle authentication system to execute:
communicating, by a network communication section, via a network with a server storing information regarding billing system functions executable by an occupant of a vehicle;
authenticating, by an authentication section, whether the billing system function can be enabled via the network communication section; and
substituting, by an alternative authentication section, for authentication by the authentication section when connection to the server cannot be established via the network communication section,
wherein
the alternative authentication section performs alternative authentication when, as a result of a disconnection from the server, the authentication section fails to determine, via the network communication section, whether the billing system function can be enabled.
